(19) United States
(12) Patent Application Publication
(10) Pub. No.: US 2002/0160305 A1
(43) Pub. Date: Oct. 31, 2002

(54) Optical recording medium, method of writing and erasing information using the same, and process of producing the same

(75) Inventors: Michikazu Horie, Kanagawa (JP); Takuya Uematsu, Kanagawa (JP); Masae Kubo, Kanagawa (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Mitsubishi Chemical Corporation, Tokyo (JP)

(21) Appl. No.: 10/059,193

(22) Filed: Jan. 31, 2002

(30) Foreign Application Priority Data
Mar. 8, 2001 (JP) P.2001-064877
Oct. 24, 2001 (JP) P.2001-326408

(51) Int. Cl. G11B 7/24

(52) U.S. Cl. 430/270.13; 369/275.2; 430/945; 428/64.5

(57) ABSTRACT

An optical recording medium having a recording layer which comprises an Sb—Te alloy containing excess amount of Sb over the vicinity of Sb₇₀Te₃₀ eutectic composition and shows reversible phase changes on light beam irradiation between a crystalline state and an amorphous state differing from each other in optical properties, a method of writing and erasing information using the same, and a process of producing the same are described.

### FIELD OF THE INVENTION

This invention relates to an optical recording medium having a rewritable phase-change type recording layer, a method of writing and erasing information using the recording medium, and a process of producing the recording medium, and in particular it relates to an optical recording medium usable at a wide range of linear velocity, a method of writing and erasing information using the recording medium, and a process of producing the recording medium.

### BACKGROUND OF THE INVENTION

Optical recording media having a phase-change type recording layer accomplish writing and erasing of information by making use of changes in reflectance with reversible changes of the crystalline state. Optical recording media of this type, especially phase-change type optical discs have been developed and extending their practical use as inexpensive large-capacity recording media excellent in portability, weatherability, impact resistance and the like. For example, rewritable compact discs (CDs), such as CD-RWs, have already spread, and rewritable DVDs, such as DVD−RWs, DVD+RWs, and DVD−RAMs, have appeared on the market.

The method of phase-change recording now practiced consists in making use of reversible changes between a crystalline phase and an amorphous phase, a crystalline phase being used as a non-recorded or erased state, where amorphous marks are formed for writing. A recording layer is usually initialized (crystallized) by heating and keeping around the crystallization temperature for a given time and made into an amorphous phase by heating to a temperature higher than the melting point followed by quenching. In other words, reversible changes between a stable crystalline phase and an amorphous phase are generally utilized.

Thin films of chalcogen alloys, such as GeSbTe alloys, InSbTe alloys, GeSnTe alloys, and AgInSbTe alloys, are of frequent use as such a phase-change recording layer. These alloys are known as materials capable of overwriting. The term “overwrite (overwriting)” denotes a recording mode in which information is recorded on a medium having information already recorded without erasing the existing information before recording, i.e., a mode of recording while erasing the existing information.

Sb—Te alloys containing Sb in excess over the eutectic composition, i.e., Sb₇₀Te₃₀ (the numbers are by atomic percent, hereinafter the same) are known as a material of a phase-change recording layer. For example, JP-A-1-303643 (The term “JP-A” as used herein means an “unexamined published Japanese patent application”) teaches use of an alloy having a compositional formula M_{y}(Sb₁₋ₓTeₓ)_{1-y} (wherein M is at least one element selected from the group consisting of Ag, Al, As, Au, Bi, Cu, Ga, Ge, In, Pb, Pd, Pt, Se, Si, Sn, and Zn, and x and y represent a ratio of the number of atoms) as a recording layer.

An alloy near an eutectic composition was formerly considered unfit for use as a recording layer of overwritable recording media because it, while having high ability to change into an amorphous state, involves phase separation upon crystallization and is therefore incapable of crystallization by heating for such a short time less than 100 nsec.

The present inventors have noted SbTe binary alloys having a composition near the eutectic composition and researched their crystal/amorphous transition characteristics by using an optical disc derive for evaluation fit for higher density recording (wavelength: e.g., 400 to 780 nm; NA of objective lens: 0.5 or more). As a result, they have found that a recording layer mainly comprising an Sb—Te alloy whose composition is near the eutectic composition Sb₇₀Te₃₀ requires specific conditions for initial crystallization but, after once initially crystallized, achieves rapid amorphous/crystalline phase changes, thereby enabling extremely speedy writing and erasing.

Another merit of using an alloy near the eutectic composition is that coarse grains whose reflectance would differ from that of an initialized state (crystallized state) hardly generate in the surroundings of amorphous marks or traces of amorphous marks after erasing. This is a phenomenon peculiar to an alloy near the eutectic composition the rate of crystal growth of which is determined by phase separation.

The above-described composition is additionally advantageous in that the recording layer produces less noisy signals than that comprising a composition near Ge₂Sb₂Te₅, a typical conventional alloy system, because coarse grains having a large strain at their boundaries are not generated around amorphous marks in mark-length modulation recording. Therefore, the composition is also suitable to a high-density mark-length modulation recording system.

### SUMMARY OF THE INVENTION

The recent increase of information has ever been generating demands for recording media capable of recording and retrieving at higher speed and higher density. The present invention has been made to meet the demands. It is an object of the present invention to provide an optical recording medium capable of high linear velocity overwriting and excellent archival stability with time.

In the light of the demands, the present inventors have conducted extensive investigations. They have found as a result that an Sb—Te material containing excess amount of Sb over the vicinity of Sb₇₀Te₃₀ eutectic composition creates a specific crystalline state having a single phase, which can be utilized as a non-recorded or erased state to realize high linear velocity overwriting and archival stability while enjoying the above-mentioned characteristics of Sb—Te alloys. The present invention has been completed based on this finding.

The gist of the present invention consists in an optical recording medium having a recording layer which contains excess amount of Sb over the vicinity of Sb₇₀Te₃₀ eutectic composition and shows reversible phase changes on light beam irradiation between a crystalline state and an amorphous state differing from each other in optical properties, wherein:

the polycrystalline state after initial crystallization mainly comprises a substantially single phase composed of hexagonal structure which is preferentially oriented,

the polycrystalline state has a columnar structure having grown in the same direction, and

the reflectance R1 of a non-recorded region of the optical recording medium after initial crystallization and the reflectance R2 of an erased region of the optical recording medium after 10th overwriting satisfy relationship (1):

ΔR (%)=2|R1−R2|/(R1+R2)×100≦10 (1)

The optical recording medium according to the present invention is capable of recording with excellent jitter characteristics for a wide range of linear velocity, particularly a high linear velocity of 10 m/sec or even higher. The excellent jitter characteristics are enjoyable even in repeated overwriting. Thus, the optical recording medium of the invention is capable of high linear velocity overwriting and excellent in archival stability. For example, there is provided an optical recording medium capable of writing and erasing at such a high linear velocity of about 14 m/sec (12× CD linear velocity or 4× DVD linear velocity) or higher.

Another gist of the present invention consists in a method of writing and erasing information using the above-described optical recording medium, which comprises conducting writing and/or erasing using a crystalline state of the recording layer as a non-recorded or erased state and an amorphous state as a recorded state.

Still another gist of the present invention consists in a process of producing an optical recording medium having a recording layer mainly comprising a composition represented by formula: SbₓTe₁₋ₓ, wherein 0.75≦x≦0.9 and showing reversible phase changes between a crystalline state and an amorphous state differing from each other in optical properties, which comprises forming at least the recording layer on a substrate and crystallizing the recording layer for initialization by scanning the recording layer with an elliptic light beam having a minor axis length of 0.5 to 5 μm in the direction agreeing with the minor axis of the beam at a scanning speed of 20% or more and less than 50% of a maximum possible linear velocity for overwriting the recording layer.

Throughout the specification and claims, subscript figures such as x, y, and z represent a ratio of the number of atoms.

### BRIEF DESCRIPTION OF THE DRAWINGS

FIG. 1 is a schematic illustration of a hexagonal Sb crystal structure belonging to the space group R3m.

FIG. 2 is a sketch of columnar crystallites substantially oriented in a given direction.

FIG. 3 schematically illustrates an apparatus for thin film X-ray diffractometry.

FIG. 4 is an X-ray diffraction (XRD) pattern of the recording layer of an optical recording medium according to the present invention.

FIG. 5 is an XRD pattern of a pure Sb thin film.

FIG. 6 shows a theoretical XRD pattern (pattern 2) obtained by simulation and an experimentally obtained XRD pattern of the recording layer of an optical recording medium accordng to the present invention (pattern 1).

FIG. 7 is a comparison of the present invention XRD pattern with a theoretical face-centered cubic structure.

FIGS. 8A and 9A are examples of transmission electron diffraction (TED) patterns of an In₃Ge₅Sb₇₁Te₂₁ thin film, in which patterns are positive.

FIGS. 8B and 9B are examples of transmission electron diffraction (TED) patterns of an In₃Ge₅Sb₇₁Te₂₁ thin film, in which patterns are negative.

FIG. 10 is a schematic view of a transmission electron microscopic (TEM) image of the recording layer of an optical recording medium according to the invention.

FIGS. 11A and 11B are a TEM image and a TED pattern, respectively, of the recording layer of an optical recording medium according to the invention.

FIGS. 12A, 12B, 12C and 12D illustrate a crystallization process of a recording layer in an optical recording medium.

FIG. 13 represents the relationship between power density of an initializing light beam and reflectance of a recording medium after initialization.

FIG. 14 graphically represents overwrite cycle dependency of mark length jitter or mark spacing jitter or data-to-clock jitter in mark-length modulation recording.

FIG. 15 is a TEM image of the recording layer of an optical recording medium.

FIG. 16 is a TEM image of the recording layer of another optical recording medium.

FIG. 17 is a TEM image of the recording layer of still another optical recording medium.

FIG. 18 is an XRD pattern of the recording layer of FIG. 17.

FIGS. 19A and 19B show schematic layer structures of optical recording media.

FIG. 20 is an example of a laser power pattern for writing an optical recording medium.

FIG. 21 is a graphical representation of the relationship between power density of an initializing light beam and reflectance of a recording medium after initialization.

FIG. 22 is a TEM image of the recording layer of the optical recording medium prepared in Comparative Example 5.

FIGS. 23A, 23B and 23C are XRD patterns of the recording layer of optical recording media having the similar composition and having been initialized under different conditions.

FIGS. 24A and 24B each presents TEM image and TED pattern of the recording layer of the optical recording medium prepared in Example, in which FIGS. 24A is of the state after initialization, and FIG. 24B the state after overall writing including erased state.

FIG. 25 presents XRD patterns of the recording layers of FIG. 24A and 24B, one is of the state after initialization, and the other the state after overall writing including erased state.

### DETAILED DESCRIPTION OF THE INVENTION

The optical recording medium of the invention has a recording layer which contains excess amount of Sb over the vicinity of Sb₇₀Te₃₀ eutectic composition and shows reversible phase changes on light beam irradiation between a crystalline state and an amorphous state differing from each other in optical properties. The polycrystalline state of the recording layer after initial crystallization mainly comprises a substantially single phase composed of hexagonal structure. The polycrystalline state is preferentially oriented and each has a columnar structure. The columnar structures have the same growth direction. The reflectance R1 of a non-recorded region of the recording layer after initial crystallization and the reflectance R2 of an erased region after 10th overwriting satisfy relationship (1):

ΔR (%)=2|R1−R2|/(R1+R2)×100≦10 (1)

The present inventors have revealed that an optical recording medium having a recording layer made of an Sb—Te alloy containing Sb in excess over a composition near an Sb₇₀Te₃₀ eutectic composition can be made to exhibit more excellent characteristics by not only optimizing the composition of the recording layer but the conditions of production.

The Sb—Te alloy takes a plurality of crystal structures depending on the composition (particularly the Sb/Te ratio) and the conditions of initial crystallization, i.e., initialization. Cases are met with in which the crystalline state of a once recorded and then erased region becomes different from the initialized non-recorded state, resulting in generation of a crystalline state showing a subtle difference of reflectance to give increased noise. In such cases, a low noise crystal phase could not be obtained unless the recording layer is repeatedly overwritten with a focused light beam or irradiated with DC light (direct current mode) to make the whole recording area into an erased state. Such operations are very laborious to manufacturers. In some cases, a plurality of crystal phases may result from the very initial crystallization to produce high noise in the non-recorded region. In short, there are cases in which initial crystallization of a formed recording layer in an ordinary manner fails to provide sufficient characteristics.

In addition, researchers on a bulk phase have pointed out that there is high possibility for the above-described SbTe eutectic composition shows phase separation into a plurality of crystal phases in perfect thermal equilibrium.

According to the phase diagram of a binary system at and around the Sb₇₀Te₃₀ eutectic point (B. Legendre et al., Thermochimica Acta, vol. 78, p. 141, etc. (1984)), the composition can take a plurality of crystal phases, such as an Sb phase, an Sb₇Te, and an Sb₂Te₃, while involving many uncertain factors. Existence of other crystal structures including a metastable crystalline phase has not been revealed.

The present inventors have noted a preferred crystal structure fit for use as a recording layer of an optical recording medium and discovered that a recording layer creates a specific crystalline state by a specific material design combined with a specific method of initial crystallization.

The present invention is primarily characterized in that the recording layer contains excess amount of Sb over the vicinity of Sb₇₀Te₃₀ eutectic composition. In a preferred embodiment, the recording layer mainly comprises a composition represented by SbₓTe₁₋ₓ (0.75≦x≦0.9). This composition is based on an Sb—Te alloy containing Sb in excess over the Sb₇₀Te₃₀ eutectic composition in a Sb—Te binary system phase diagram (hereinafter referred to as an eutectic system). In the present invention, the crystalline state is used as a non-recorded or erased state, and a locally formed amorphous mark provides a recorded state.

The preferred composition SbₓTe₁₋ₓ (0.75≦x≦0.9) will be described in detail.

In order to facilitate creation of the specific crystal structure featuring the present invention and to stabilize an amorphous state, the amount of Sb as represented by x is equal to or smaller than 0.9. As hereinafter described, the Sb/Te ratio is preferably 3 or higher so as to prevent generation of face-centered cubic crystals in addition to hexagonal crystals in a crystallized state. That is, x/(1−x) is preferably equal to or greater than 3, which is equivalent to 0.75≦x. Still preferably, x/(1−x)≧3.5, which is equivalent to 0.78≦x. Particularly preferably, x/(1−x)≧4.0, which is equivalent to 0.8≦x.

Such an eutectic system recording layer is usually amorphous immediately after film formation. The term “amorphous” is used here to describe not only a completely amorphous state over the whole recording layer but an amorphous state containing slightly crystallized portions. Therefore, the recording layer as formed requires instantaneous heating called an initial crystallization operation. The recording layer having the thus crystallized state is then melted locally by irradiation with a writing focused light beam having a beam diameter of 1 μm or smaller and quenched to form amorphous marks.

In the present invention, a recording layer is formed on a disc- or card-shaped substrate, and then an region of the said recording layer which is larger than the irradiation area of the focused light beam used for writing/retrieving is crystallized at a time. This operation is called an “initial crystallization operation” or sometimes “initial crystallization”, “bulk initial crystallization”, “bulk initialization” or simply “initialization”. The initial crystallization is conducted in almost the final stage of recording medium manufacture. This operation is needed for making the recording medium ready to be recorded by an user. More specifically, the initial crystallization is carried out by scanning the recording layer as guided by the track provided on the disc or card with a beam having an irradiation area about 10 or more times larger than that of the focused light beam used for writing and retrieving.

The present inventors have found that such an initial crystallization operation can result in generation of various crystal phases and orientation states depending on the initialization conditions and that the characteristics as an optical recording medium largely vary depending on the crystal phases. The present invention aims to specify a favorite crystalline state after the bulk initialization. The favorite crystalline state is reached by a specific initialization method hereinafter described.

In general, a crystalline state obtained by heating a very small area of about 1 μm in diameter as with a focused light beam for writing and retrieving followed by cooling, i.e., a local erased state obtained by recrystallizing an amorphous mark is not the same as the crystalline state obtained by bulk initial crystallization effected over an area at least 10 times as large as the above-described small area. This is because the difference in heated area results in differences in temperature distribution and temperature change of the heated area. Further, as hereinafter described, recrystallization in an eutectic alloy system recording layer as in the present invention proceeds chiefly through crystal growth starting from the boundaries between an amorphous region or a molten region (a region having been heated and melted by irradiation) and the surrounding crystalline region, while involving little nucleation within the amorphous or molten region. Accordingly, the difference in area of the region where recrystallization proceeds influences the crystal growth and ultimately the orientation of the resulting polycrystalline structure. This means nothing less than difficulty in substantially equalizing the crystalline state after erasing of amorphous marks with a write/retrieve focused light beam to that after initial crystallization.

To the contrary, the present invention makes it possible to make the crystalline state obtained by initial crystallization and that obtained by erasing amorphous marks by irradiation with a write/retrieve focused light beam have substantially the same crystalline phase and preferential orientation, thereby succeeding in reducing noise of reproduced signals. The language “substantially the same crystalline phase” as used herein is intended to mean that almost no optical difference is detectable with a write/retrieve light beam. By this strategy retrieved light reflected on or transmitted through the optical recording medium has no subtle fluctuations of output which may cause noise. The erased state is obtainable through either a process in which a molten region directly recrystallizes in a re-solidification process without amorphization or a process in which a molten region is once amorphized and then recrystallized in a solid phase under heating above the crystallization temperature. The erased state cannot be obtained where the amorphous state after film formation crystallizes in a solid phase without experiencing a molten state. Therefore, it is desirable that the initial crystallization operation be such that the recording layer is once melted before recrystallization as hereinafter described.

Hence, the present invention have succeeded by controlling the crystalline state after initial crystallization in drawing improved overwrite characteristics from an optical recording medium having an eutectic system recording layer in which crystallization from an amorphous phase proceeds chiefly through crystal growth, and in said optical recording medium, the crystalline state is used as an erased state and the amorphous state as a recorded state.

The inventors have found it necessary that the polycrystalline state after initial crystallization should mainly comprise a substantially single phase composed of hexagonal structure and that the polycrystalline state be preferentially oriented in order to obtain satisfactory characteristics as an optical recording medium. More specifically, they have found it necessary that the polycrystalline state after initial crystallization should mainly comprise a substantially single phase composed of hexagonal structure and that the crystallites (crystal grains) be moderately fine and preferentially oriented to make up a polycrystalline structure.

The term “a substantially single phase” as used herein denotes a polycrystalline state in which the individual crystallites have the same basic crystal structure, i.e., belong to the same crystal group and have the same lattice constants. The term “preferential orientation” denotes a state in which most of the crystallites are oriented to have the same specific plane parallel to the plane of the recording layer. The expression “moderately fine” as used for the crystallites is used to describe crystallites whose length in columner growth is shorter than the maximum amorphous mark length. It is required that the length of crystallites having grown into a columnar shape should not exceed 10 times larger than the minimum mark length. The term “plane of the recording layer (recording layer plane)” denotes the plane perpendicular to the thickness direction of an optical recording medium.

In order to ensure that the initially crystallized state and the crystallized state obtained by erasing an amorphous mark by irradiation with a write/retrieve focused light beam may have substantially the same crystalline phase and preferential orientation, it is essentially required that the individual polycrystalline has a columnar structure having grown in the same direction and that the reflectance R1 of a non-recorded region obtained after initial crystallization and the reflectance R2 of an erased region obtained after 10 direct overwriting (DOW) cycles satisfy relationship (1):

ΔR (%)=2|R1−R2|/(R1+R2)×100 ≦10 (1)

It is desirable for securing satisfactory performance as an optical recording medium that the initialized non-recorded state be made mainly of a substantially single phase composed of hexagonal Sb structure which belong to the space group R3m, with part of Sb atoms displaced with Te atoms, and said hexagonal crystals being preferentially oriented.

It is more desirable that this initialized crystalline state be composed solely of hexagonal Sb structure belonging to the space group R3m with part of Sb displaced with Te.

In case phase separation occurs to make a mixed crystal phase comprising, in addition to the Sb hexagonal crystals, other crystal phases such as an Sb₇Te, an Sb₂Te₃, a crystal structure that belong to the same hexagonal system but have largely different lattice constants compared with the Sb hexagonal crystals of the present invention, cubic crystals such as Sb in high temperature, face-centered cubic structure such as those of AgSbTe₂, and others belonging to other space groups, grain boundaries with a great stacking fault will be formed. It seems to follow that the mark edge is disturbed or optical noise generates. A substantially single phase composed of the above-described specific hexagonal structure brings about excellent results probably because such grain boundaries with large strain or anisotropy are not formed.

With the polycrystalline structure of a substantially single phase as described above, it is necessary for reducing noise ascribed to the anisotropy or grain boundaries thereby to form satisfactory amorphous marks that a specific plane of the individual crystal lattices be oriented in parallel to the recording layer plane, i.e., be in a preferentially oriented state. It is desirable for the individual crystallites (grains) to have a moderately controlled size. In other words, the individual crystallites are desirably fine enough not to develop such anisotropy as to be distinguishable with write/retrieve light. Since hexagonal crystals per se are structurally more anisotropic than cubic crystals, if the individual crystallites have their orientation plane, extending in different directions, or if their sizes are much larger than the wavelength or diameter of a write/retrieve light beam, the noise ascribed to the grain boundaries would become unfavorably large. Further, the anisotropy inherent to hexagonal crystals could be a bar to reduction of noise. These conceivable disadvantages have made it difficult to apply eutectic system materials near Sb₇₀Te₃₀ to optical recording media for high-density recording.

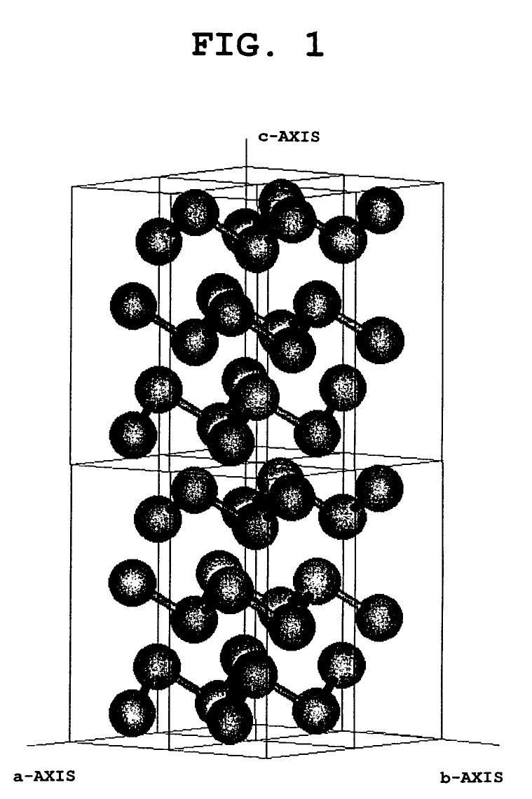

From these viewpoints, it is preferred in the present invention that the crystals making up the single crystal phase basically comprise Sb hexagonal crystal unit cells belonging to the space group R3m as shown in FIG. 1 with part of Sb atoms randomly substituted with Te atoms. Compared with other crystal phases of Sb—Te alloys that can take a hexagonal structure but have Te atoms at specific regular positions, such as an Sb₇Te and an Sb₂Te3, the Sb crystals having Te at random positions are preferred for reducing the anisotropy.

Random substitution with Te means dissolution of Te in the matrix Sb, forming a solid solution. Because —Te— bonds introduced into the Sb network as a result of random substitution of Sb with Te are more two-dimensional and more flexible than —Sb—Sb— bonds, they gradually change their bonding state on an atomic level (i.e., their bond angle or atomic distance) to moderately change the orientation gradually and subtly. That is, the crystalline structure is allowed to fluctuate to relieve strain. As a result, accumulation of strain due to discontinuous change of crystallinity and orientation in grain boundaries is prevented thereby suppressing noticeable manifestation of anisotropy. Thus, even when the crystallites (grains) have a relatively large size, the adverse influences of anisotropy and grain boundaries can be suppressed.

If, in a polycrystalline structure composed of hexagonal Sb structure, a crystallite has perfect crystalline structure allowing no fluctuation of crystallinity and orientation (hereinafter simply referred to as “fluctuation of orientation”), the strain would be concentrated in the grain boundary in an attempt to stabilize the single-phase polycrystalline state. If, in addition, individual crystallites do not show the same orientation, hexagonal crystals would rather exhibit large anisotropy and have difficulty in reducing noise. Further, the grain boundaries would develop great strain, and light can scatter at the boundaries to cause noise. If the edge of an amorphous mark is positioned on such a microscopic gap, the edge would be discrete, making it more difficult to reduce noise (jitter).

It should be noted that the terminology “fluctuation of orientation” as used in the present invention means minor fluctuations in lattice axes or crystal planar direction with the crystallographic structure and lattice orientation being fixed. Specifically, the degree of orientation fluctuations that can be regarded minor is within about ±20% in terms of variations of lattice axis length and within about ±20% in terms of variations of planar direction. As hereinafter discussed, the basic pattern of transmission electron diffraction (TED) or X-ray diffraction (XRD) does not reveal change with such fluctuations of orientation. That is, orientation fluctuation is not distinguishable as a change in a TED pattern or a shift of a peak position in an XRD pattern but is primarily detectable as a change of density in a transmission electron microscopic (TEM) image.

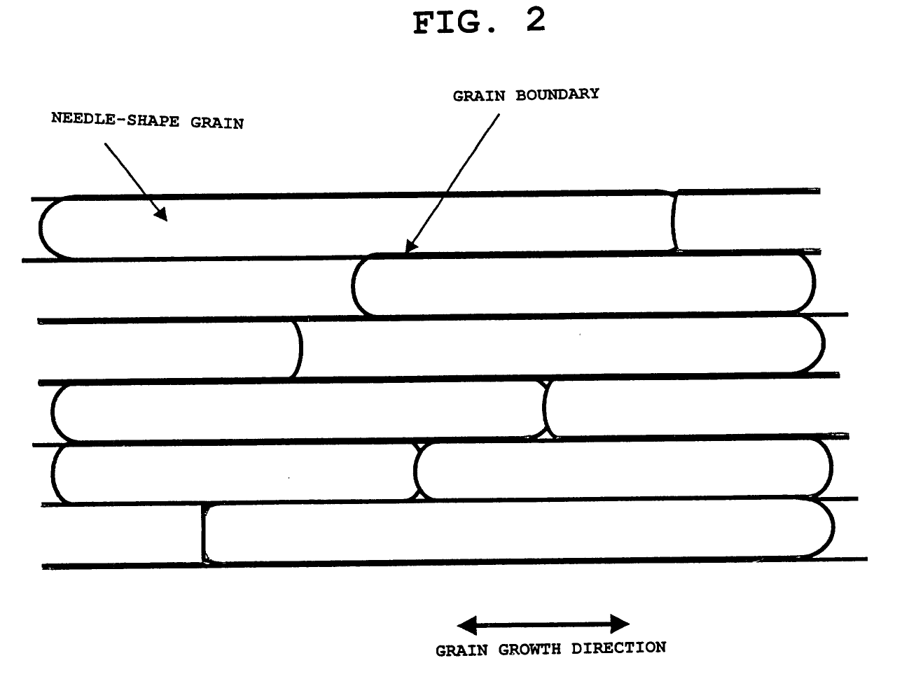

As shown in FIG. 2, the polycrystalline state of the recording layer as obtained by initial crystallization should be composed of columnar crystallites having grown in the same direction. The growth direction is preferably almost along the light beam scanning direction. When we say that crystallites have the same growth direction, it does not mean that the crystallites have the same growth direction all over the recording layer but that crystallites have the same growth direction over an area sufficiently larger than a writing laser beam diameter. An area “sufficiently larger” would be on a scale of about 10 times a writing laser beam diameter. It is preferred that the columnar structures do not have clear grain boundaries and show continuous and subtle fluctuations of orientation in their growth direction. Columnar structures having an aspect ratio of about 10 or greater will be particularly referred to as “needle-shape crystals (or crystallites or structures)”.

With the width and length of the needle-shape crystallites being not more than about 0.5 μm and not more than about 10 μm, respectively, adverse influences of anisotropy can be suppressed. Where crystallites which are strictly in the same orientation state are greater than the above grain size, there is a tendency that crystallites with a rigid structure which hardly allows subtle orientation fluctuations in lattice constants or bond angles would be incapable of sufficiently reducing strain concentration in grain boundaries, which may result in formation of distinct boundaries.

The length of the needle-shape crystallites is about equal to or smaller than the maximum amorphous mark length and is usually 10 μm or smaller. It should not exceed about 10 times the minimum amorphous mark length at the longest. It is preferred for the length be longer than about 0.5 μm to suppress increase of grain boundaries due to extreme grain fineness.

It is desirable that the non-recorded region of the recording layer after initial crystallization have a period of orientation fluctuations, which are observed as density variations in a TEM image, of not more than about 0.5 μm. Applied to the needle-shape crystallites, this means that the period of orientation fluctuations, observed as density variations in a TEM image, in the width direction (while the grain boundaries in the width direction may be sometimes vague) is desirably smaller than about 0.5 μm for the most part and that continuous orientation fluctuations desirably occur also in the length direction at a period of about 0.5 μm or less due to minute strains of the crystal structure on an atomic level without forming a grain boundary. Orientation fluctuations occurring at such a period produce virtually the substantially same effects as obtained where fine crystal grains of about 0.5 μm at the greatest are formed, whereby the optical anisotropy inherent to hexagonal crystals can be reduced.

It is a preferred embodiment that the growth direction of the columnar structures be approximately along the light beam scanning direction. With the growth direction of the columnar structures, i.e., the longer axis of the needle-shape crystallites being approximately in the scanning direction of a write/retrieve focused light beam, it is possible to decrease the difference in structure between the crystalline state after initial crystallization and that after overwriting and erasing and thereby to reduce the trace of erasing. Needle-shape crystallites are formed through preferential growth of a specific crystal plane. It also means that the crystallites have a specific plane oriented in parallel with the recording layer plane, i.e., preferentially oriented.

The crystal structure of an erased state after overwriting is surely a polycrystalline structure composed of single phase hexagonal crystallites the size of which is sufficiently smaller than the amorphous mark width (e.g., about 0.5 μm) and generally does not exceed 0.1 μm for the greatest part. The growth direction is, while not completely, approximately along the focused light beam scanning direction. Anyhow the growth directionality of the crystallites is almost symmetrical about the centerline of scanning beam because crystal grows proceed symmetrically about the centerline of the focused beam. While the crystallites have their specific plane oriented in parallel with the recording layer plane, it is preferred that their orientation be the same as in the crystalline state after initial crystallization. Approximation of the crystalline state after initial crystallization to that after overwriting (erased state) is particularly important for maintaining erasing performance in high-speed recording and reducing jitter after overwriting; for overwriting in high-speed recording is carried out by scanning with a focused light beam at a high speed.

It is preferable that the Sb—Te solid solution be doped with a third element M described later for the purpose of finely adjusting the optical constants of the recording layer or suppressing nucleation. It is desirable that Sb, Te, and the third element M form a hexagonal Sb crystal-based solid solution in which part of Sb atoms are displaced with Te and M. The recording layer used in the optical recording medium of the present invention is preferably made of a material mainly comprising such a solid solution.

There is a good possibility that the above-described solid solution assumes a metastable state obtained by melting an eutectic composition followed by quenching at such a high cooling rate that does not cause amorphization. This metastable state is extremely stable when stored at about room temperature. Segregation due to re-arrangement of Te or M or transition to a different crystal phase hardly proceeds in the practice in the storage.

The third element M is preferably at least one element selected from the group consisting of Al, In, Ga, Ge, Si, Sn, Pb, Bi, Pd, Pt, Zn, Zr, Hf, V, Nb, Ta, Cr, Co, Mo, Mn, O, N, S, and Se. These elements are effective for fine adjustment of optical constants of the recording layer or suppression of nucleation.

The preferred composition containing M is represented by formula: M_{y}(SbₓTe_{1-y})_{1-y} (x is as defined above). The total amount of M represented by y in the above formula is preferably y≦0.2, still preferably y≦0.1. Preferably y is 0.001≦y. In case of using plural atoms for M, the amount of such plural atoms is preferably equal or less than 0.2. As far as y is 0.2 or smaller, (1) M atoms are prevented from co-precipitating with Sb or Te, (2) ease of obtaining a single-phase crystal phase, which is one of the characteristics of the invention, is secured, (3) writing noise is reduced, and (4) jitter reduction particularly in high-density mark-length recording is facilitated. With y being 0.2 or smaller, noise of recorded signals after repeated overwriting tends to reduce.

Of the above-recited elements M, those highly covalent-bondable (Ge, Si, Sn, N, and Pb) are highly effective in stabilizing the metastable crystal structure as long as they are introduced into the crystal structure at random. Cares should be taken, however, in deciding the amount to be introduced because too much introduction can result in a rigid crystal structure that has no more flexibility for allowing orientation fluctuation. From this viewpoint, Ge is a particularly preferred third element for the following reasons. Ge produces a specifically pronounced effect in removing remaining crystal nuclei with little impairment of the crystal growth rate of the basic Sb—Te eutectic system, thereby drawing the full advantage of the eutectic system material of the invention that follows a crystallization process relying chiefly on crystal growth. Doping with Ge is also effective in forming the hexagonal crystal structure preferentially and stably.

In using Ge as M, 0.001≦y≦0.08 is preferred, and 0.001≦y≦0.05 is still preferred. With y being 0.08 or smaller, jitter tends to be reduced. With y being 0.001 or greater, the inhibitory effect of Ge on nucleation is pronounced. Where Ge is used, it is advisable to use at least one of Ga and In in combination. In this case, the recording layer is preferably made of a material mainly comprising a composition represented by formula: A_{z}Ge_{y}(SbₓTe₁₋ₓ)_{1-y-z}, wherein A represents at least one of In and Ga; 0.75≦x≦0.9; 0.001≦y≦0.08; and 0.03≦(y+z)≦0.1.

The atomic ratio of (A+Ge), i.e., (y+z) is preferably 0.03 to 0.1. Addition of element A is effective in stabilizing amorphous marks and controlling the crystallite size. It is preferred that the amount of element A be larger than the amount of Ge.

Too much doping with Ge, In, and Ga tends to result in appearance of Ge—Te system phases, making it difficult to generate a single phase, which is the same as with excessive doping with other elements.

Where other elements are added in addition to Ge, In, and Ga, the total amount of the other elements should be 5 atom % or less at the most. For securing formation of a hexagonal crystal single phase, the total amount of the other elements is preferably not more than 3 atom %. Addition of highly ionic-bondable elements is unfavorable because they cause loss of crystal structure flexibility. The amount of oxygen as M, if added, is preferably as low as 2 atom % at the highest. The addition of the element(s) M is exclusively for producing additive effects, such as fine adjustment of optical characteristics, fine adjustment of crystal size, and improvement of archival stability.

The preferred eutectic system material of the present invention which mainly comprises M_{y}(SbₓTe₁₋ₓ)_{1-y} (0.75≦x≦0.9) is characterized in that deletion of amorphous marks on a recording layer made of this material is governed substantially solely by crystal growth starting from the edges of the amorphous marks surrounded by a crystal region. In other words, nucleation in amorphous marks and resultant crystal growth therefrom make little contribution to the recrystallization process.

In order to achieve overwriting at a higher linear velocity, i.e., to accomplish erasing in a shorter time, the amount of Sb is increased as reported by M. Horie et al. in Proceedings of SPIE, vol. 4090, p. 135 (2000). In that case, an increase of Sb is considered to result in acceleration of crystal growth. That is, an increase in Sb amount accelerates recrystallization from the crystalline region surrounding an amorphous mark and also accelerates crystal growth in re-solidification following melting.

In general, there is a possibility that such high-speed erasing, i.e., high-speed crystallization cannot be achieved without sacrificing archival stability of amorphous marks. However, the recording layer material used in the present invention is characterized in that erasing by crystal growth at such a high temperature as elevated by a focused light beam proceeds at a high speed because crystal growth predominates over nucleation and that, on the other hand, recrystallization of amorphous marks is extremely slow at relatively low temperatures as in an atmosphere where recording media are stored. The reasons are as follows. The rate of nucleation in a crystallization process reaches the maximum at a much lower temperature than the melting point as compared with crystal growth rate so that nucleation gradually proceeds at relatively low temperatures to form small crystal grains. On the other hand, crystal growth proceeds only in high temperatures right below the melting point. Therefore, recrystallization is inhibited from proceeding in low temperature only if nucleation is inhibited.

The term “archival stability” as referred to herein means stability of amorphous marks with time, i.e., resistance against erasing when the recording medium is stored at room temperature. When a recording medium has poor archival stability, crystallization proceeds to make amorphous marks smaller.

In the present invention, the crystallization rate, particularly the crystal growth rate can be selectively controlled by specifying the Sb/Te ratio, which makes it possible to satisfy two conflicting requirements—recrystallization of amorphous marks by a temperature rise (erasure) and suppression of recrystallization of amorphous marks at around room temperature.

Accordingly, the eutectic system recording layer used in the optical recording medium of the invention is specially suited to overwriting by scanning with a write focused light beam at a linear velocity as high as 10 m/sec or more. Specifically, the invention provides an optical recording medium which is capable of overwriting at such a high linear velocity of about 14 m/sec (corresponding to a 12× CD linear velocity or a 4× DVD linear velocity) or higher and excellent in archival stability.

Thus, optical recording according to the present invention consists in use of the crystalline state as a non-recorded or erased state and the amorphous state as a recorded state, wherein the crystalline state comprises a single phase of a hexagonal crystal system composed of moderately fine needle-shape crystallites which are preferentially oriented while allowing gradual orientation fluctuation within the crystallites so as to reduce the strain in the grain boundaries. While the recording may be either mark position recording or mark length recording, the latter is preferred for high-density recording. The recording medium of the invention is particularly suitable for such high-density recording as has the shortest mark length of equal or less than about 0.4 μm.

When an amorphous mark is formed on the crystalline structure (non-recorded or erased state) of the recording layer of the optical recording medium according to the invention, the outline of the amorphous mark is smooth without being interrupted by grain boundaries thereby preventing jitter on the mark edges.

Since the shape of an amorphous mark is decided by competition between amorphization occurring on re-solidification of a molten region and recrystallization from the surrounding crystalline region, the amorphous mark size is controllable by controlling the recrystallization process. Therefore, the optical recording medium of the invention is also fit for a multi-level recording system in which multi-level variations in reflectance with mark sizes are detected.

Competition between an amorphization process and a recrystallization process is essentially noticeable with the recording layer composition used in the invention. However, if crystal growth from the periphery of an amorphous mark in a recrystallization process is made discontinuous by the grain boundaries, it would be difficult to control the recrystallization process and to form an amorphous mark having a desired size. Notwithstanding the crystalline structure adopted in the invention excludes the influences of the grain boundaries upon the outline of an amorphous mark, facilitating formation of a mark with a smooth and continuous outline and a desired size.

The crystalline state of the Sb—Te alloy thin film can be distinguished through TED and XRD. As a matter of course, a sample to be analyzed by TED or XRD must be taken from a recording layer prepared according to a layer structure design and a process that are as close as possible to those of an actual optical recording medium. Such an experimental sample as prepared by forming a film on a glass substrate and annealing in an oven for initial crystallization is unsuitable.

A sample for TED or XRD is prepared as follows. The optical recording medium of the invention usually comprises a substrate and a stack of a recording layer and a dielectric protective layer provided on at least one side of the recording layer. The surface of the film side of the medium is scratched and peeled off with an adhesive tape to expose the recording layer. The substrate or the substrate plus the dielectric layer on the other side of the medium is/are then removed by abrasion or dissolution to obtain a recording layer sample having a thickness which transmits an electron beam.

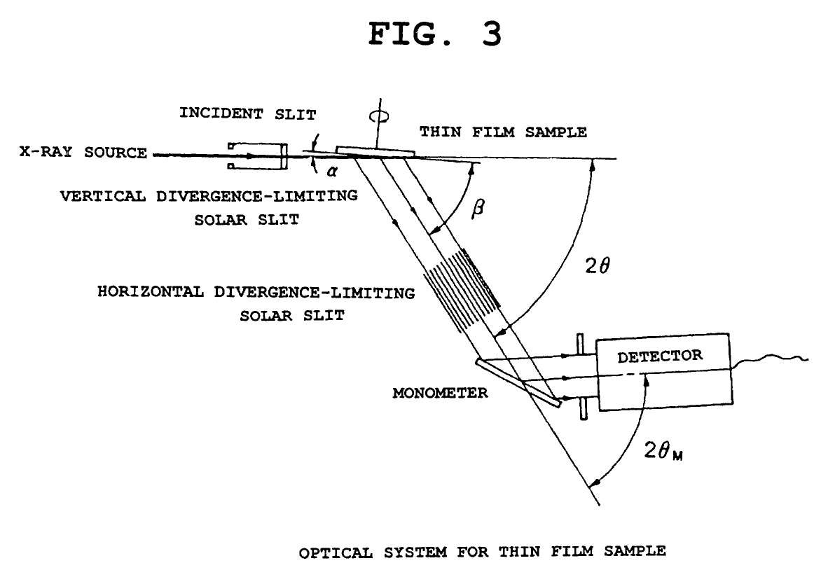

For XRD, while the sample thus prepared (with both sides of the recording layer exposed) is useful, a sample having only one side of the recording layer exposed suffices. In the present invention, XRD is usually carried out with the latter sample according to a thin film XRD method, in which an X-ray beam is incident on the sample making a small angle a with the sample plane (see FIG. 3) to penetrate to a small depth so as to observe the crystalline state of only the thin film on the outermost surface of the sample while suppressing diffracted or scattered waves from the substrate.

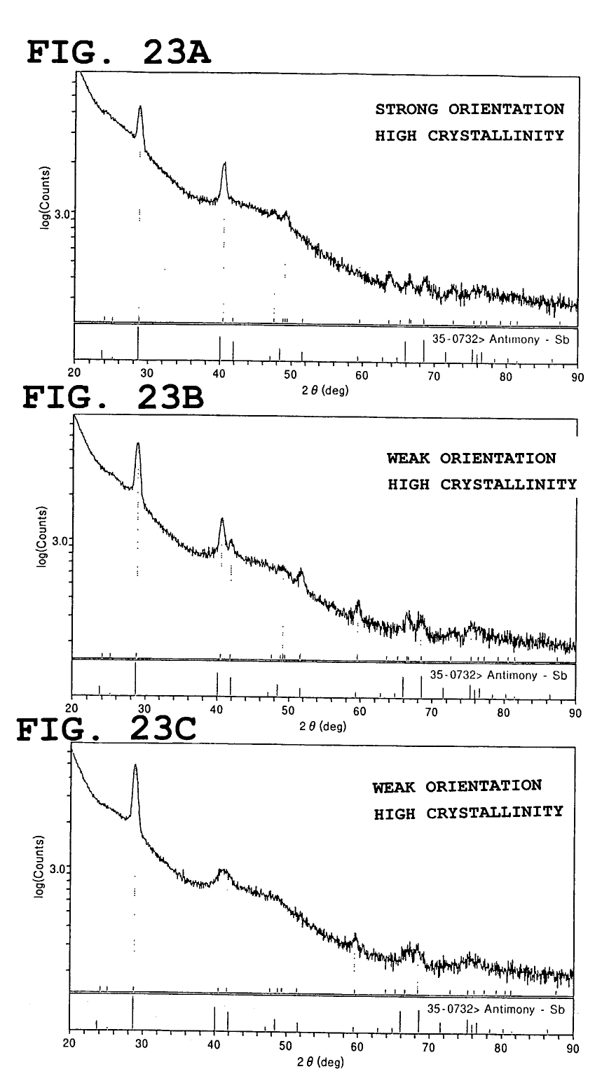

The present inventors have studied intensively the states obtained by initializing the recording layer of the invention under various conditions which are substantially polycrystalline and show markedly increased reflectances over the amorphous state. As a result, there have been found three types of crystalline states represented by the XRD patterns shown in FIGS. 23A, 23B, and 23C. All the figures show the state after initialization and before irradiation with a write/retrieve focused light beam. Dependence of the XRD pattern on initialization conditions is a phenomenon common to recording layer compositions containing Sb in excess over a composition near the eutectic composition, Sb₇₀Te₃₀. In other words, this phenomenon appears as far as a recording layer has an Sb—Te alloy composition containing Sb in excess over a composition near Sb₇₀Te₃₀ and has little dependence on the kinds or amounts of trace elements added.

The XRD patterns shown in FIGS. 23A to 23C are inclusive of the diffraction of the substrate and the protective layer as a background. In each of the Figures, diffraction peaks of Sb hexagonal crystals obtained from a standard database Powder Diffraction File (PDF) are shown in the form of a histogram below the abscissa of the XRD pattern (in the place where figures “135-0732”, which is the database number, are printed out). The bars right on the abscissa in each XRD pattern indicate adjusted positions of diffraction peaks obtained by finely adjusting the lattice constants of the data, with the crystalline structure being equal, so as to have the closest agreement with the experimentally obtained diffraction peak positions. The most intensive peak appears at a diffraction angle 2θ of about 28° in every diffraction pattern. The state shown in FIG. 23C is the least crystalline, implying existence of a residual amorphous structure, as is seen from the broader peaks. The state of FIG. 23B is highly crystalline, being almost completely polycrystalline. However, this pattern shows division of the peak at 2θ of about 40° into two peaks and is considered to be the closest to a powder diffraction pattern of random hexagonal crystals. FIG. 23A also indicates high crystallinity and complete polycrystallinity but shows strong specific orientation as proved by disappearance of part of peaks. The most preferred crystalline state is the one represented by the XRD pattern of FIG. 23A showing a clear, non-divided peak at a diffraction angle 2θ of about 40°. The next most preferred is the one represented by the pattern of FIG. 23B. A state represented by the pattern of FIG. 23C has relatively low reflectance on account of insufficient crystallization and fails to satisfy the relationship (1) for ΔR.

The most preferred crystalline state of FIG. 23A will further be described in detail.

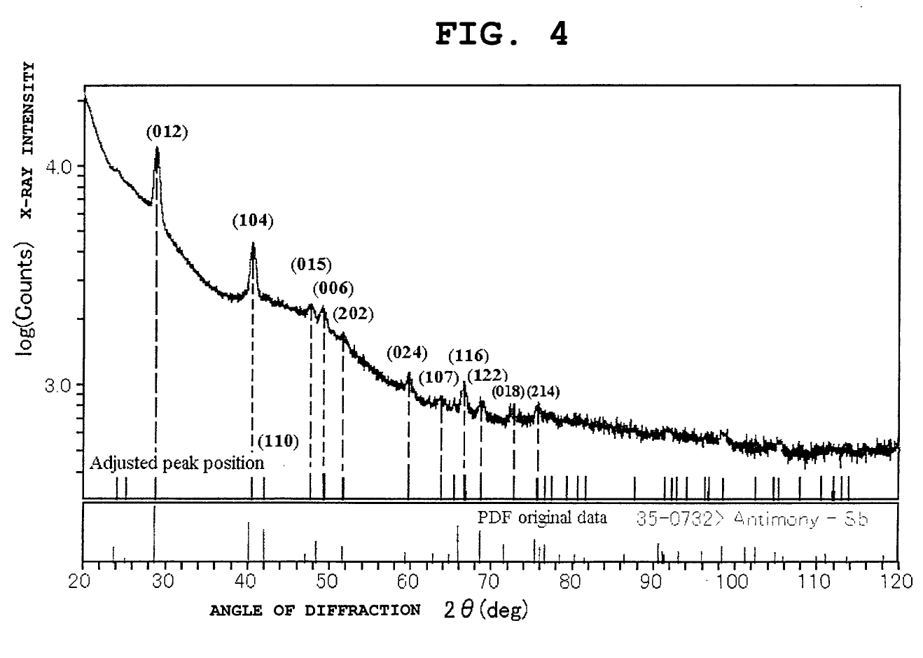

FIG. 4 provides an XRD pattern of the most preferred crystalline state after initialization. The sample is composed of a polycarbonate resin substrate having an under ZnS:SiO₂ protective layer (amorphous) and an exposed recording layer having a thickness of about 200 Å. The sample was prepared by peeling an upper protective layer off the recording layer to expose the underlying recording layer. CuKα radiation was used as an X-ray source.

The histogram depicted in the lower part of FIG. 4 is an XRD pattern of R3m hexagonal crystals of Sb (in FIG. 1, a-axis length=b-axis length=4.307 Å; c-axis length=11.273 Å) obtained from a standard database of XRD patterns (powder samples); PDF:35-0732. Although the XRD pattern of the Sb thin film almost agrees with the original data from PDF with respect to the number of peaks and their 2θ angles, close comparison reveals subtle differences in peak intensity ratio and 2θ angle.

These differences reflect differences of lattice constants with the crystal structure being equal. Then the lattice constants of the PDF:35-0732 data were adjusted so as to give a pattern closest to the experimentally obtained pattern. As a result of this fitting procedure, the lattice constants of the hexagonal crystals under analysis were found to be 4.31 Å for a-axis and b-axis and 11.11 Å for c-axis. The bars on the abscissa of the XRD pattern indicate theoretical positions of the peak for each plane as calculated by using the resulting a-axis (=b-axis) and c-axis lattice constants based on the crystal structure shown in FIG. 1 as suggested by the PDF database (adjusted peak positions).

No considerations given to peak intensity, not all the theoretical peaks are observable. It is seen from FIG. 4 that the positions of main peaks are in good agreement with any one of the adjusted peak positions. Seeing that the (012) plane at a 2θ of about 28°, specifically about 28.8°, is the predominant peak, it is understood that the crystals are preferentially oriented with the (012) plane being substantially in parallel to the recording layer plane.

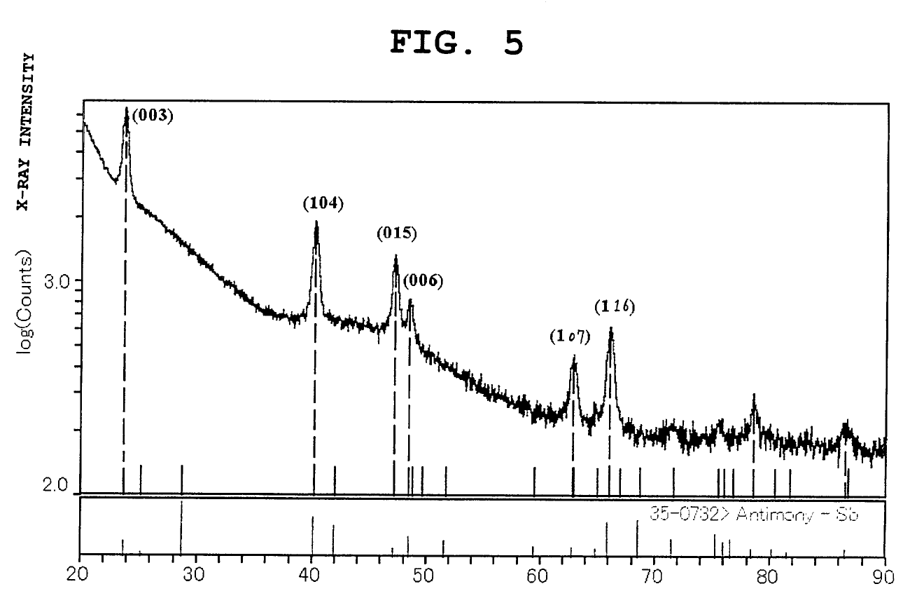

On the other hand, FIG. 5 shows a diffraction pattern of a sputtered pure Sb thin film (thickness: ca. 200 Å; layer structure of the sample: the same as the sample used in XRD measurement of FIG. 4) obtained with the same thin film XRD system as used above. The film was crystalline immediately from after film formation and required no initialization. The XRD pattern of the film agrees very closely with the PDF:35-0732 data in peak position. The lattice constants obtained by the fitting were 4.295 Å for a-axis and 11.254 Å for c-axis, which are approximate to the database values (a-axis=b-axis: 4.307 Å; c-axis: 11.273 Å). As for orientation, the predominant peak is for the (003) plane appearing at 2θ=ca. 24.2°, and the (012) plane peak at 2θ=ca. 28.8° disappears almost completely. It is understood from these observations that the c-axis stands more perpendicularly to the thin film plane (so-called “c-axis orientation”) . c-Axis orientation is rather naturally observed in a crystalline thin film of a metal or an alloy havin a hexagonal structure. This indicates that the specific crystal structure of the recording layer used in the invention is not always naturally obtained just because it mainly comprises Sb and is based on the hexagonal crystals of Sb. Only a specific initial crystallization operation hereinafter described can provide the specific crystal structure.

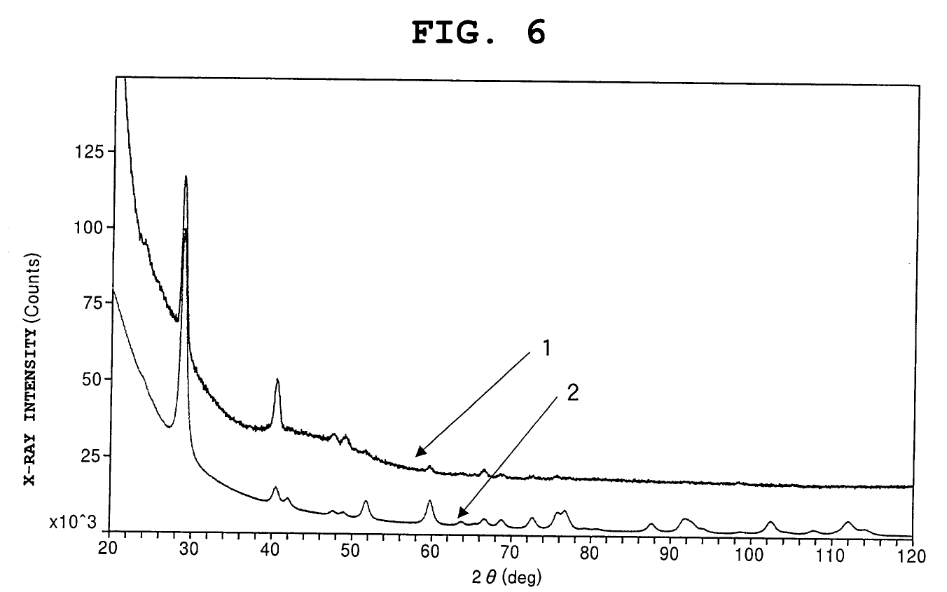

FIG. 6 shows a theoretical XRD pattern (pattern 2) obtained by a simulation based on the R3m crystal structure of FIG. 1 taking the fittest lattice constants and the orientation (peak intensity ratios) into consideration in comparison with the experimental XRD pattern of FIG. 4 (pattern 1). The two patterns show exact agreement in position of peaks up to high diffraction angles. We can reach the conclusion that the crystal structure of FIG. 4 belongs to the space group R3m of Sb shown in FIG. 1 with slight changes of lattice constants.

The peak division around 2θ=40°, particularly the branch in the higher angle side, appearing in the theoretical XRD pattern 2 is unclear in the experimental pattern 1. This shows the peak corresponding to the (110) plane in the higher angle side is very weak in the latter. According to the method of measurement adopted here, this is further not inconsistent to the conclusion that the (012) plane is almost parallel to the thin film plane. In addition, other peaks such as the (300) plane peak are also unclear in the pattern 1, which is consistent with what has been discussed above, seeing that these planes are parallel with the c-axis of FIG. 1. It should be noted, however, that these peaks are weak by nature and that their disappearance does not always prove that the c-axis stands “perpendicularly to the film plane” in view of the limited precision of thin film XRD. The disappearance should rather be interpreted to imply that these planes are undetected because they “stand at some angle (at most about 20°)” from the film plane, which is not inconsistent to the conclusion that (012) plane is almost parallel to thin film plane.

Where a trace element is disposed at specific positions of an Sb lattice as in an Sb₇Te phase, which is hexagonal crystals, a long-period structure is added. For example, the c-axis length of the Sb₇Te phase is as long as about 34 Å. Therefore, whether or not the substitution with the other element(s) is at random can be judged by whether a TEM or XRD pattern has a peak assigned to the long-period structure. As compared with the diffraction pattern of the Sb₇Te phase (PDF:46-1068), the pattern of the recording layer according to the invention has few peaks in common at high angles even with slight strain taken into account. It has also been confirmed that the pattern of the recording layer according to the invention shows no clear peaks attributed to other crystal structures belonging to a hexagonal system, such as an Sb₂Te₃ phase (corresponding to PDF:15-0874) and an Sb₂Te phase (corresponding to PDF:80-1722).

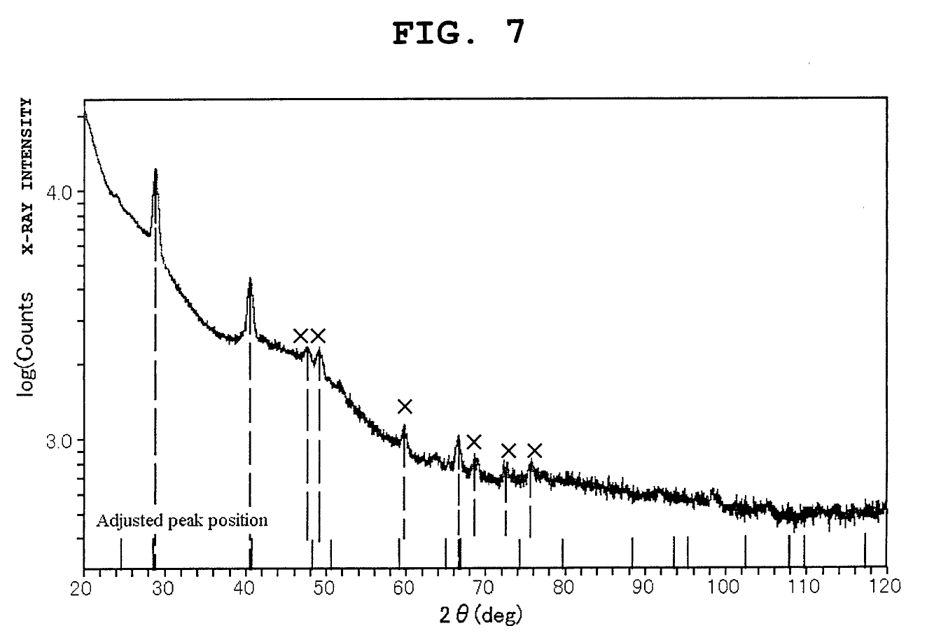

A comparison with XRD pattern of face-centered cubic (fcc) crystals is shown in FIG. 7. The bars on the abscissa indicate peak positions optimized using only the a-axis as a parameter, assuming fcc. Glancing the main peaks in a 2θ angle range of about 40° or smaller, the pattern has similarity to that of the recording layer used in the invention. However, close observation over a broader 2θ angle range obviously reveals large differences.

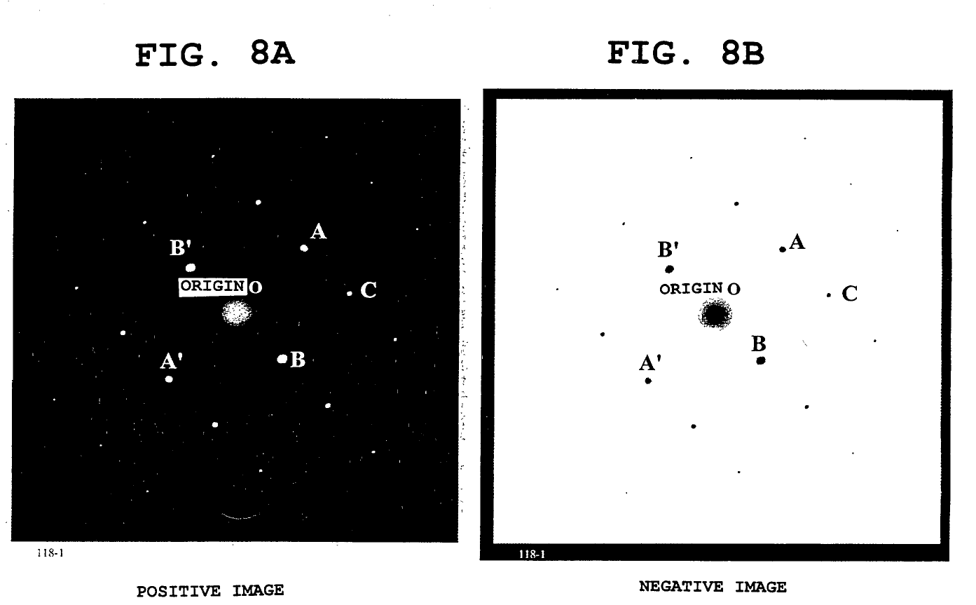

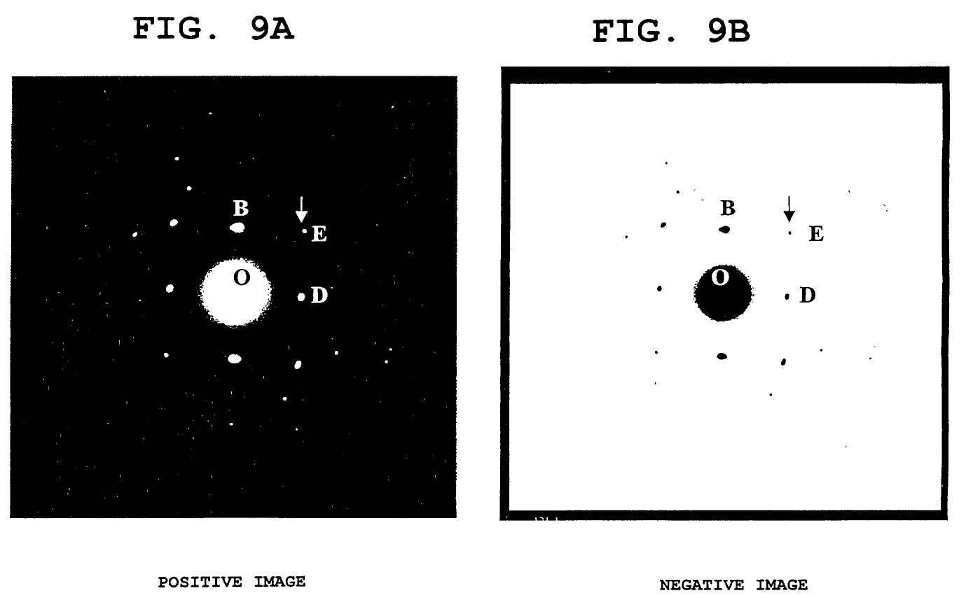

FIGS. 8A, 8B, 9A and 9B present TED images of the same sample of an In₃Ge₅Sb₇₁Te₂₁ thin film prepared by peeling a recording layer (thickness: about 20 nm) from a phase-change type optical recording medium prepared in the same manner as in Examples hereinafter given, where the electron beam was applied perpendicularly to the thin film plane. The recording medium had been initialized and not been irradiated with a write/retrieve focused light beam. FIGS. 8A and 9A each is a positive image, and FIGS. 8B and 9B each a negative image. Points A to E are assigned to Miller indices (2, −1, 0), (012), (202), (1, −1, 2), and (104), respectively.

Point O is an origin obtained as an intersection of lines connecting symmetric points of the indices. For example, point O of FIG. 8A or 8B is an intersection of the line connecting point B (012) and point B′ (0, −1, −2) and the line connecting point A (2, −1, 0) and point A′ (−2, 1, 0). At a glance, these diffraction points appear to form a rectangle, corresponding to a cubic crystal. However, the angle ∠AOB in FIG. 8A or 8B deviates from 90°, and the angle ∠DOB in FIG. 9A or 9B also deviates slightly from 90°. It is a hexagonal crystal structure belonging to the space group R3m that can prove the Miller indices of the points A, B, C, D, E, etc. appearing in these diffraction images without contradiction.

FIGS. 8A and 8B each shows a TED pattern of a crystalline state having the (104) plane paralleled almost accurately by the recording layer plane, and FIGS. 9A and 9B each a TED pattern with the (012) plane almost in parallel with the recording layer plane. Both patterns are obtained with an electron beam incident vertically on the recording layer. The (104) plane and the (012) plane make an angle of about 20°, and both crystalline states depict the XRD pattern of FIG. 4 the predominant peak of which is the peak of the (012) plane. While these two crystalline states may be present in a mixed state, it is preferred for the recording layer to mainly comprise the crystalline state having the pattern of FIG. 9A or 9B, because such an orientation is closer to the orientation in an erased state (crystallized state) after overwriting.

As discussed above, the state after initial crystallization can be judged by putting together an XRD pattern, a TEM image, and a TED pattern.

The TED patterns of FIGS. 8A (8B) and 9A (9B) are those obtained from different fields of view with an electron beam focused to about the size of a single crystal grain (about 0.4 μm) according to a selected area electron diffraction method. The sample provided substantially only those patterns ascribed to the R3m structure while involving rotation of a planar direction, which also verifies a single phase of the crystalline state.

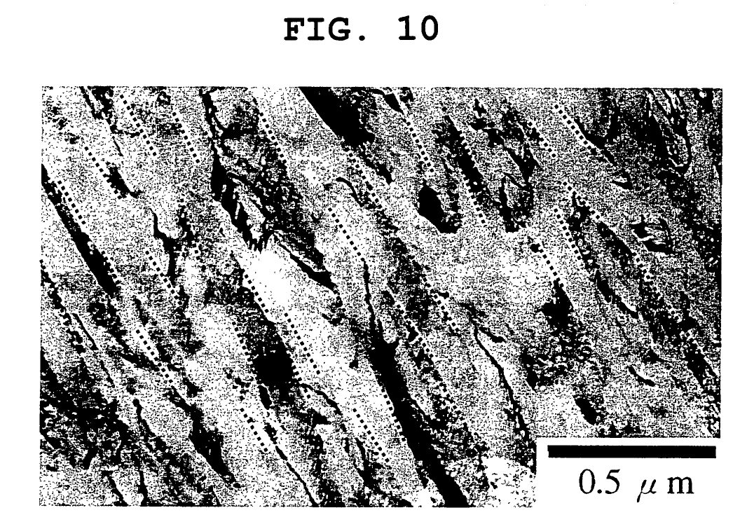

FIG. 10 is a schematic view of a TEM image of a recording layer in a recording medium of the invention after initialization and before irradiatin with a write/retrieve focused light beam. The continuous changes in contrast observed in the image do not indicate grains having different crystal structures but fluctuations of orientation, i.e., variations in planar direction and interplanar spacing due to crystal structure strain as a result of gradual variations in bond angle and lattice spacing. All the grains have hexagonal structure which is preferentially oriented in the same direction with the (012) plane in parallel with the recording layer plane as shown in FIG. 9A or 9B. On the other hand, the discontinuous and steep changes in density indicated by dotted lines in FIG. 10 are considered to correspond to grain boundaries, showing a large number of needle-shape crystallites having a width of about 0.1 to 0.2 μm and a length of several microns.

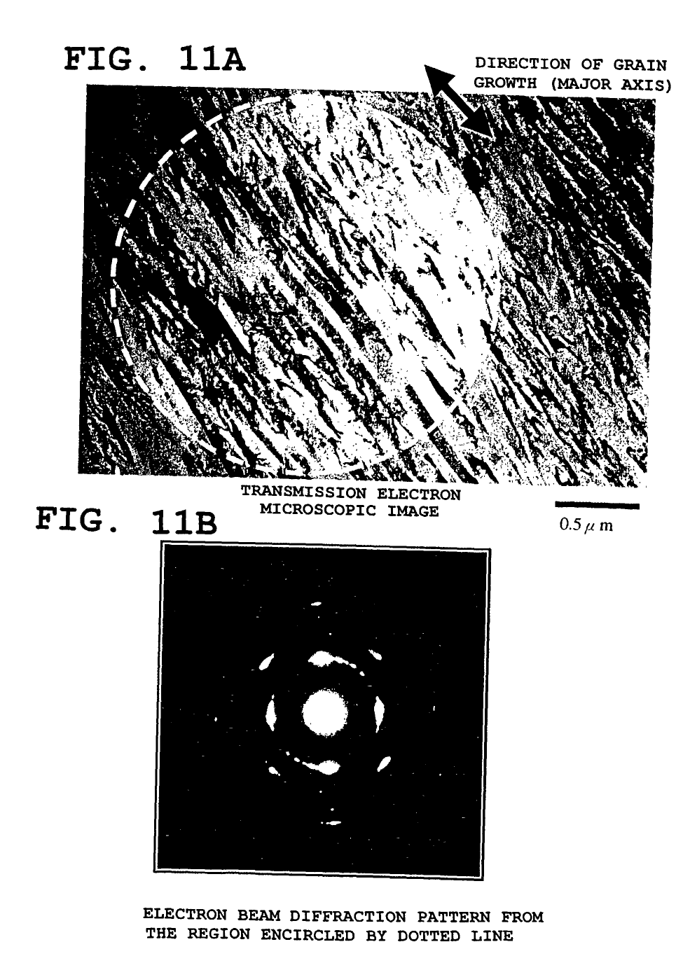

The crystallites have grown along a given direction. That is, the needle-shape crystallites have grown in the same direction, and the planar direction (orientation) fluctuates inside the individual crystallites too slightly to be distinguished by XRD. More specifically, the preferentially oriented plane which is substantially parallel to the recording layer plane may be inclined within a range of about ±20% with respect to the recording layer plane. Further, the grain boundaries, particularly boundaries along the longer axis, i.e., the growth direction, are vague, indicating that strain has been hardly accumulated there. FIG. 11A is another TEM image, and FIG. 11B is a TED pattern from a relatively large field indicated by the dotted line in FIG. 11A, obtained with an electron beam having a diameter of about 1.2 μm.

The TED pattern of FIG. 11B is not a ring pattern commonly observed with a random polycrystalline structure but a pattern having a strong diffraction intensity in a specific direction. It is seen that the orientation direction is almost the same as a whole in a large field containing several tens of needle-shape crystals, except for slight fluctuations. The growth direction of the columnar structures appears to be parallel with the direction indicated by the arrow in FIG. 11A. While the image does not tell which of the forward and the backward directions of the arrow the crystallites have grown, what is important is that the columnar crystallites have the same growth direction.

Such columnar structures allow strain to be introduced inside to cause fluctuations of orientation, which is considered effective to prevent strain's being accumulated in grain boundaries due to abrupt changes of orientation in the grain boundaries even though the grains are somewhat great. Middle-range structures corresponding to an area, a diameter of about several microns which contains several crystallites, also depict a TED pattern with a strong diffraction intensity in a specific direction. Therefore, it is considered that the polycrystalline structure of FIG. 11A is not randomly but preferentially oriented in a specific direction and is composed of needle-shape crystallites having grown in their major axial direction while maintaining the preferential orientation.

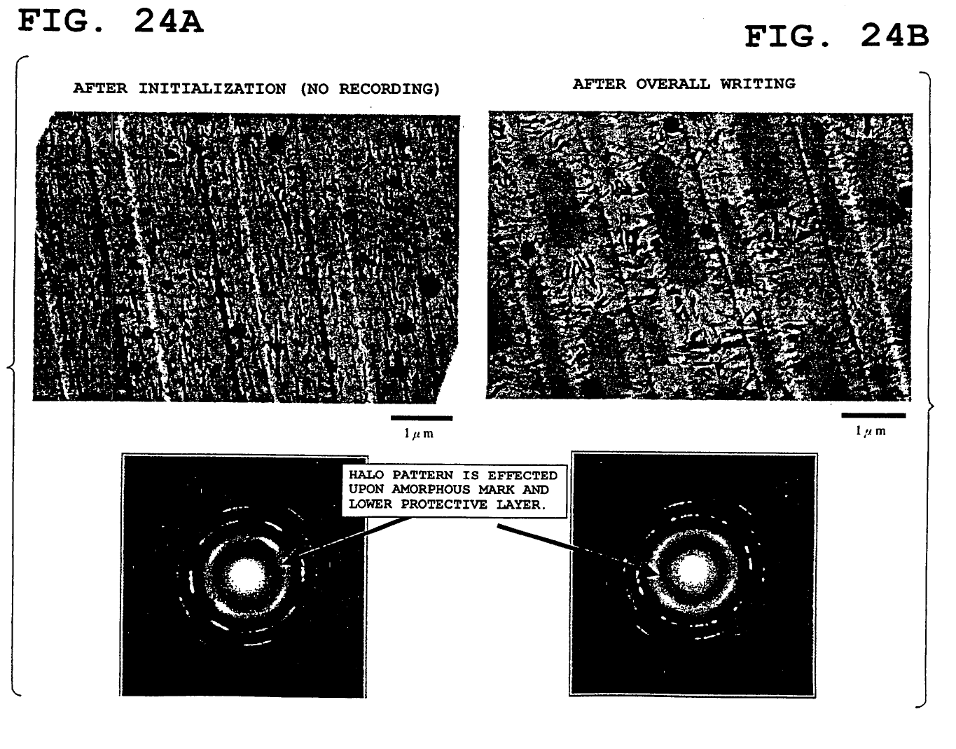

FIGS. 24A and 24B each shows TEM patterns and TED images of a crystalline state equivalent to that of FIG. 10. FIG. 24A is a state after initial crystallization of the recording layer prepared in Examples (before irradiation with a write/retrieve focused light beam), which is also equivalent to the state shown in FIGS. 11A and 11B. FIG. 24B is a crystalline state after overwriting on both grooves for guiding a write/retrieve focused light beam and lands (the area between the grooves) several times followed by erasing. As can be seen from the TEM image of FIG. 24B, the growth direction of columnar structures is not always fixed, but the TED pattern of the state of FIG. 24A and that of the state of FIG. 24B show the same pattern under observation over a large field containing a plurality of crystallites as in FIG. 11B. It would be safe to consider that the crystalline diffraction pattern of FIG. 24B is obtained from the crystalline state after erasing, because, while the TED image of FIG. 24B has a halo pattern (a white blurred ring) as a result of influences of an amorphous mark and an amorphous protective layer attaching to the recording layer, the diffraction pattern appearing as intensive white spots is the same as that of FIG. 24A. This diffraction pattern proves that the (012) plane is oriented substantially in parallel with the recording layer plane as is observed in FIGS. 9A, 9B and 10.

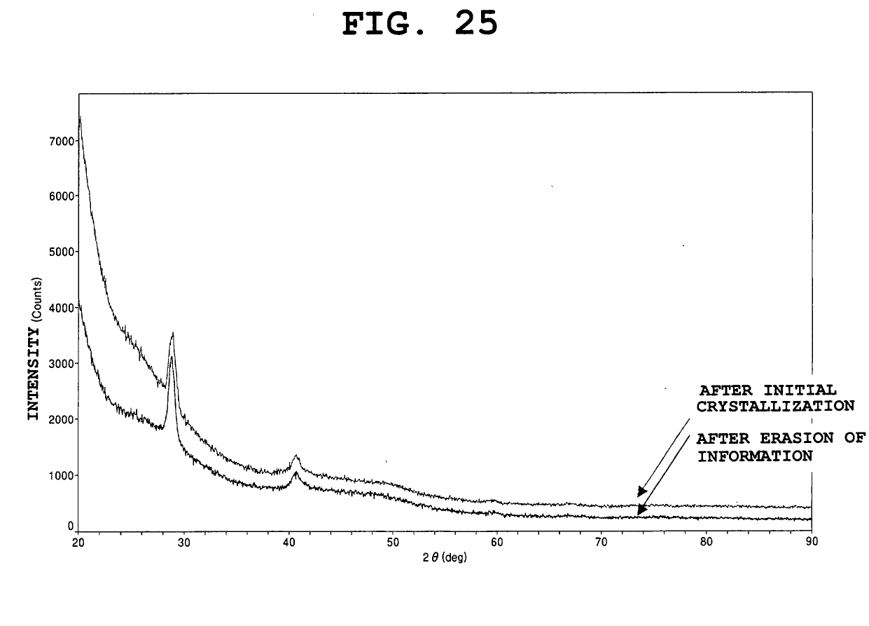

FIG. 25 shows XRD patterns of the above-described samples. It is seen that the crystalline state after initial crystallization and that after overwriting including by erasing with a focused light beam are practically the same, being equivalent to the pattern of FIG. 4, and that both crystalline states have a predominant peak assigned to the (012) plane. What is significant here is that the non-recorded crystalline state after initial crystallization and the crystalline state of an erased region after overwriting with a focused light beam have the same direction of preferential orientation.

The above-discussed characteristics of the crystal structure in the recording layer, particularly the non-recorded crystalline structure after initial crystallization, and the superiority of that structure are generally qualitatively defined by analyzing the XRD pattern, TED pattern and TEM image as a whole. It is also possible to quantitatively define a preferred crystal structure by specifying the following parameters.

First of all, attention is to be paid to the diffraction peak for the (012) plane, the predominant peak appearing at 2θ of around 28° (specifically about 28.8°). In general, a shift of the (012) plane peak position toward a higher angle side as compared with a crystal pattern of a powder sample suggests an extension of an average interplanar spacing (about 3 Å) of the (012) plane as a result of bonding strain on an atomic level. The shift is consistent with a model in which crystallites grow in a substantially the same direction into needle-shape grains while retaining the basic hexagonal crystal structure and keeping the (012) plane substantially in parallel to the recording layer plane but with strain occurring at least between (012) planes on account of subtle fluctuations of orientation.

In the present invention strain is dispersed on an atomic level by incorporating Te into the Sb crystal structure at random. It follows that orientation variation takes place within the individual grains continuously and gradually thereby preventing strain concentration on the grain boundaries. Paying attention to the interplanar spacing of the (012) planes as a parameter of imperfect crystallinity inside crystallites is by no means arbitrary, seeing that Te is taken into the Sb crystal structure at random. Accordingly, in the present invention, the effect of atomic level strain dispersion is quantitatively specified by a shift of the peak position for the (012) plane at 2θ of about 28.8° to give a criterion for quantitatively judging whether a crystalline state is the state preferred as a recording layer.

It is preferred for the predominant peak in an XRD pattern prepared by using CuKa radiation as an X-ray source to be at a position within a 2θ angle range of from 28.70° to 28.85° as a result of random substitution of Sb with Te. Where the position of this peak is at 2θ≦28.85°, the internal strain is released so as not to form clear grain boundaries. Where the position is at 2θ≧28.70°, the grain structure is stable, being prevented from changing into a pure Sb structure having the peak shifted to a larger 2θ. A 2θ range of from 28.75° to 28.85° is still preferred for suitability to high-speed overwrite recording, which range corresponds to an extremely narrow range of an interplanar spacing of from about 3.090 to 3.105 Å.

A c-axis or a-axis length of hexagonal crystal unit cells can be taken as another criterion of atomic bond level strain. Acurate lattice constants can be obtained by fitting the lattice constants of the crystal structure shown in FIG. 1 so as to agree with the found values of an XRD pattern or a TED pattern. In the present invention, the lattice constants vary under the influences of substitution of Sb with Te. It is preferred that the c-axis length of the hexagonal crystal unit cells be shorter than that of pure Sb hexagonal crystal unit cells (according to PDF:35-0732, a-axis length: 4.307 Å; c-axis length: 11.273 Å). It is still preferred that the a-axis length be from 4.30 to 4.33 Å and that the c-axis length be from 10.9 to 11.25 Å. A particularly preferred structure fit for high-speed overwrite has an a-axis length of 4.31 to 4.33 Å and a c-axis length of 11.0 to 11.2 Å. Most part of the change in interplanar spacing of the planes (012) seems to owe to the change in the c-axis length.

It is preferred that the predominant peak of an XRD pattern obtained by a thin film XRD method using CuKα radiation as an X-ray source be a peak representing the (012) plane of the hexagonal crystals and that the half-value width to the maximum height of the predominant peak with only CuKα1 radiation, which depends on a crystal size and crystallinity, be in the range of from 0.6 to 0.8°, particularly from 0.64 to 0.76°. The effects of the present invention will be manifested remarkably where the hexagonal crystals have a controlled crystalline state as specified by the above half-value width to the maximum height obtained only with CuKα1 radiation.

As described above, the recording layer composition used in the invention is characterized by a high crystal growth rate and little nucleation in initial crystallization. These characteristics will be recognized obviously by comparison with a recording layer made of a GeTe—Sb₂Te₃ pseudo-binary alloy system for the following reasons.

Generally speaking, crystal growth in initialization takes place through two stages—nucleation and growth from the resulting crystal nuclei. Crystallization proceeds in a temperature range above the crystallization temperature and below the melting point, primarily in a relatively high temperature range near the melting point, whereas nucleation primarily proceeds in a relatively low temperature range near the crystallization temperature.

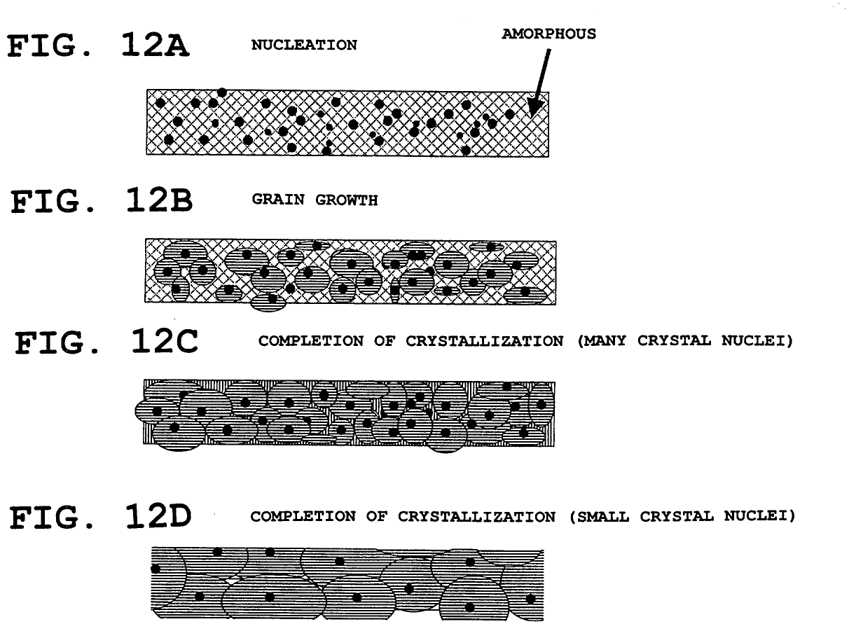

Under initialization conditions close to a thermally equilibrated state such that crystallization in the recording layer proceeds in a solid phase without experiencing a molten state, crystal nuclei generate with elevation in temperature as illustrated in FIG. 12A. On further raising temperature, nucleation reaches saturation, and the existing nuclei start growing into grains (crystallites) as shown in FIG. 12B. At last the grains cover the entire surface of the recording layer as shown in FIG. 12C to complete crystallization.

When the eutectic system recording layer of the invention is initialized through the above-mentioned crystallization process, the individual grains can gain in size, sometimes reaching several tens of microns, as shown in FIG. 12D because the structure has a high crystal growth rate with nucleation suppressed markedly. The nuclei can also grow dendritically to form island structures, leaving amorphous parts among islands. Phase separation inherent to an eutectic system can also occur.

This is the very reason why the recording layer used in the invention calls for special considerations for initialization in order to obtain the specific crystalline structure which comprises a substantially single phase composed of preferentially oriented hexagonal crystals and yet has strain dispersed in the inside of the individual crystallites on an atomic level. In order to form the above-described preferred crystal phase, the initial crystallization of the recording layer is preferably carried out as follows.

In what follows, the method of initializing the recording layer, which is another important aspect of the present invention, will be described. The recording layer is usually formed by physical vacuum deposition such as sputtering. Since the layer as deposited is usually amorphous, it should be crystallized to create a crystalline state ready to be recorded. This operation is called initialization. General initial crystallization operations include solid phase annealing at a temperature above the crystallization temperature (usually 150 to 300° C.) and below the melting point, such as oven annealing or irradiation with light energy, e.g., laser light or flash lamp light, and melt-quenched initialization. Of these methods, melt-quenched initialization is preferred for obtaining the above-mentioned preferred crystalline state. This is because the columnar growth as sketched in FIG. 2 is so-called dendritic growth, which is one of the crystal growth morphologies commonly observed in re-solidification of molten metal. In the case of solid phase annealing, other undesired crystal phases tend to generate during the time for reaching thermal equilibrium, and an amorphous state is liable to remain in places.

In carrying out melt-quenched initialization, too slow recrystallization tends to allow other crystal phases to generate during the time for reaching thermal equilibrium. Therefore the cooling rate is desirably increased to some extent. It is unfavorable to keep the molten state for too a long time because such will make the recording layer to flow, cause thin films (e.g., a protective layer) to be separated by stress or deform the resin substrate, etc., resulting in destruction of the medium.

For instance, a preferred time for maintaining the recording layer at or above the melting point is usually not longer than 10 μsec, preferably 1 μsec or shorter. Melt initialization is preferably conducted by using a laser beam. It is particularly preferred to use a laser beam having an elliptic profile with its minor axis substantially in parallel with a scanning direction (this initialization mode will be sometimes referred to as “bulk erasure” or “bulk initialization”). The elliptic beam profile used for bulk erasure usually has a major axis length of 10 to 1000 μm and a minor axis length of 0.1 to 5 μm.

The major and the minor axis lengths as referred to herein with reference to an elliptic beam are decided from the half-value width of the light energy intensity distribution of a beam. In order to secure locallized heating and rapid cooling in the minor axis direction, the minor axis length is preferably 5 μm or shorter, still preferably 2 μm or shorter.

Various lasers such as semiconductor lasers and gas lasers are usable as a lase beam source. The laser power is usually about 100 mW to 10 W. The power density actually irradiated on the recording layer (laser beam power x power efficiency/irradiation area) for initialization is usually 4 mW/μm² or higher, preferably 4.4 mW/μm² or higher, still preferably 4.5 mw/μm² or higher. The preferred power density makes it easier to obtain an initialized crystalline state composed of the specific preferred hexagonal crystals. Other light sources, such as a xenon lamp, can be used as far as an equivalent power density and an equivalent beam profile as desirable conditions mentioned above are obtained.

Bulk erasure of, for example, a disc-shaped recording medium is carried out by scanning the disc with an elliptic beam with its minor axis agreeing with the circumferential direction of the disc by rotating the disc and moving the beam in its major axis direction (i.e., the radial direction of the disc) for every round to complete overall initialization. The resulting polycrystalline structure has orientation in a specific direction with respect to a write/retrieve focused light beam that is guided by a track spirally provided along the circumferential direction.

The pitch of beam's movement in the radial direction per round is preferably shorter than the major axis length of the beam to make overlaps in the radial direction. This will not only ensure initialization but prevent non-uniformity of initialized state which may result from an energy distribution in the radical direction (usually 10 to 20%). Note that too small a pitch tends to result in formation of other unfavorable crystalline phases. A suitable pitch of beam's movement in the radial direction is at least half of the major axis length of the beam.

Whether a melt-quenched recrystallization process has succeeded in obtaining the optical recording medium of the invention can be confirmed by (1) whether columnar crystallite structures are observed under a TEM image as shown in FIG. 10 and (2) whether the reflectance R1 of a non-recorded state after initialization and the reflectance R2 of an erased state after 10th overwriting with a write/retrieve focused light beam with a spot diameter of about 1 μm that is to be actually used are substantially the same.

Accordingly, the reflectances R1 and R2 of the optical recording medium of the invention should satisfy relationship (1):

ΔR (%)=2|R1−R2|/(R1+R2)×100≦10 (1)

The reason the reflectance R2 after 10 overwrite cycles is used as a parameter for judgement is that 10 overwrite cycles would be enough to exclude the possible influences of reflectance from any residual crystalline state which may be left after recording only once and guarantee that every part of the recording area has experienced a recrystallization process by erasure at least once. On the other hand, if the overwrite cycle number largely exceeds 10, changes in reflectance could be induced by factors other than the phase change, such as microscopic deformation due to repeated overwriting and diffusion of foreign elements from the protective layers, making it difficult to judge whether or not an optical recording medium as purposed has been obtained.

It is desirable that ΔR, defined by relationship (1), be 5% or less for securing lesser signal noise.

As one embodiment of relationship (1), a phase change recording medium the R1 of which is about 17% is required to have an R2 of about 16 to 18%. The scanning speed of an initializing energy beam usually ranges from about 3 to 20 m/sec.

The write/retrieve focused light beam used for overwriting and erasing to determine the reflectance R2 does not always need to be modulated according to a pulsation system actually used. That is, the erased state having the reflectance R2 can be obtained by irradiating the recording layer with DC write power to cause the recording layer to melt followed by re-crystallization by erase power.

In order to obtain the desired initial crystalline state of the eutectic system material of the invention, setting the speed of scanning the recording layer plane with the initializing energy beam is of special importance. Considering that the importance of the invention lies in creating a crystalline state similar to the crystalline state in an erased region after overwriting, it is desirable, in principle, that the linear velocity (relative to the rotating recording layer) of the initializing beam be close to that of a focused light beam actually used to overwrite. Specifically, the recording layer is scanned with an initializing energy beam at a linear velocity in a range of from about 20 to 80% of the maximum possible linear velocity used in overwrite recording.

The “maximum possible linear velocity” for overwriting as referred to herein is such that irradiation with a DC erase power Pe at this linear velocity results in an erasure ratio of 20 dB or more. An “erasure ratio” is a difference between the carrier level of signals from amorphous marks recorded at a substantially single frequency and the carrier level after erasure by DC irradiation with erase power Pe. An erasure ratio can be measured, for example, as follows. Amorphous marks are overwritten at a single frequency 10 times under such recording conditions as to provide sufficient signal characteristics satisfying prescribed properties such as reflectance, signal amplitude, jitter, etc., and the carrier level (C.L. as recorded) is measured. The recording frequency is chosen from high frequencies of a mark-length modulated signals (made of repetition of the shortest mark and space) to be recorded. Then the amorphous marks are erased by DC irradiation with a vaired erase power Pe, and the carrier level (C.L. as erased) is measured. The difference between the C.L. as recorded and the C.L. as erased gives an erasure ratio (dB). There is a general tendency that an erasure ratio once increases on increasing the DC erase power Pe from about read power, then the erasure ratio decreases, and again increases. The first erasure ratio peak observed when the erase power Pe starts increasing is taken as an erasure ratio of the sample.

Where the scanning speed of an initializing energy beam is lower than about 20% of the thus specified maximum overwriting linear velocity, phase separation tends to occur, and a failure of obtaining a single-phase polycrystalline structure can result. If a single phase could be obtained, the crystallites tend to grow excessively along the scanning direction into giant grains or be oriented in unfavorable directions. A preferred scanning speed for initialization is 30% or more of the maximum possible linear velocity for overwriting.

Where, on the other hand, the scanning speed of an initializion energy beam exceeds about 80% of the maximum possible linear velocity for overwriting, which speed may be seen as almost equal to the maximum possible linear velocity of overwriting, the irradiated and melted region will undergo amorphization. This is because such a high scanning speed results in too high a cooling rate of the molten region, giving an insufficient time allowance for re-solidification to complete recrystallization. In writing with a focused light beam having a diameter of about 1 μm, recrystallization of a molten region through crystal growth from its periphery completes in such a short time. In initialization with an elliptic light beam, however, the molten region has a larger area extending along the major axis. Therefore, it is necessary to lower the scanning speed than that for actual overwriting so as to let a recrystallization process in re-solidification cover the entire area of the larger molten region. From this viewpoint, the scanning linear velocity of the initializing energy beam is preferably 70% or less, still preferably 60% or less, particularly preferably 50% or less, of the maximum linear velocity for overwriting.

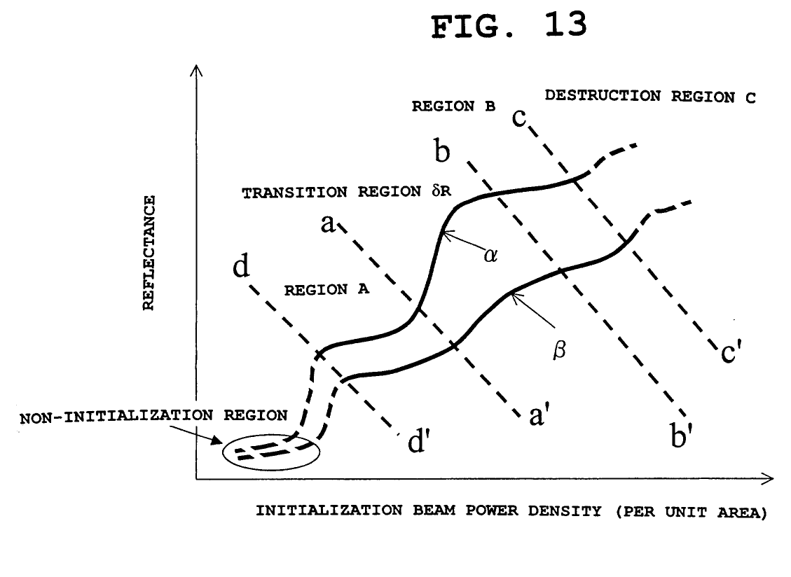

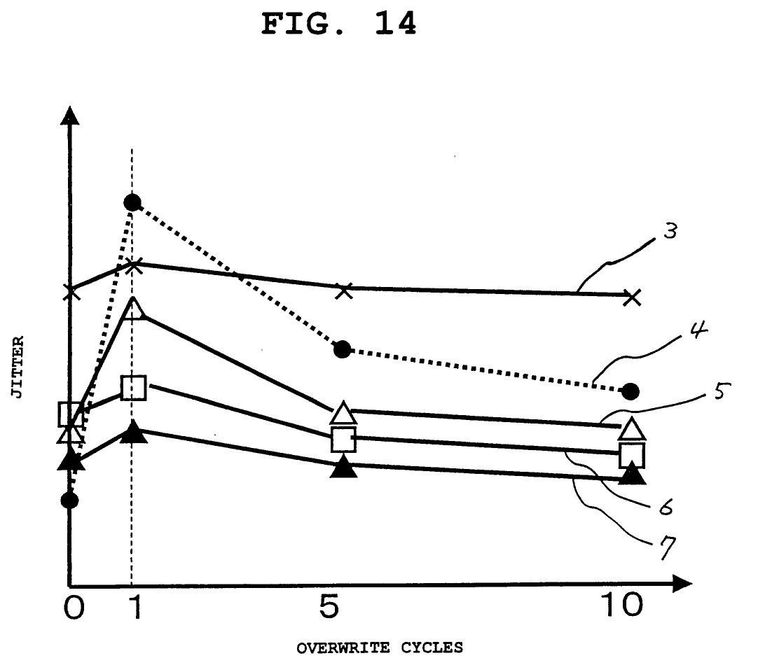

It is desirable that the scanning linear velocity and irradiation power for initialization be decided by retrieving the reflectance of the crystalline phase after initialization with a retrieve light beam as hereinafter described. FIG. 13 represents the schematic relationship between retrieved light output Ig which corresponds to the reflectance R1 of a recording medium as initially crystallized and power density of the initializing light beam per unit area with the scanning linear velocity of the initializing beam being changed. Ig is usually obtained as an output from a light detector which is proportional to a retrieved light intensity when a recording layer is scanned with a retrieve focused light beam with focus servo and tracking servo on. In using a disc-shaped recording medium, Ig is usually obtained as an average of Ig values as measured along a recording track for a whole one round circumference at a certain radius. While FIG. 13 is a representation of a particular case in which an elliptic laser beam having a minor axis length of about 1 μm and a wavelength of about 800 nm was used for initialization, it seems that practically the same results would have been obtained with other energy beams having a similar profile. Curve α of FIG. 13 is the reflectance vs. power density relationship obtained when the recording layer is initialized by scanning at a relatively low linear velocity, i.e., below about 20% of the maximum linear velocity actually used for overwriting. As depicted by curve a, the Ig once increases in a low power density range and then plateaus in region A. FIG. 14 graphically represents direct overwrite (DOW) cycle dependency of mark length or mark spacing jitter or data-to-clock jitter in mark-length modulation recording.

Zero DOW cycle means first recording on the non-recorded state after initialization, and 1 DOW cycle is first overwriting on the first recorded state. Jitter once reaches a steady state at about 10 DOW cycles.

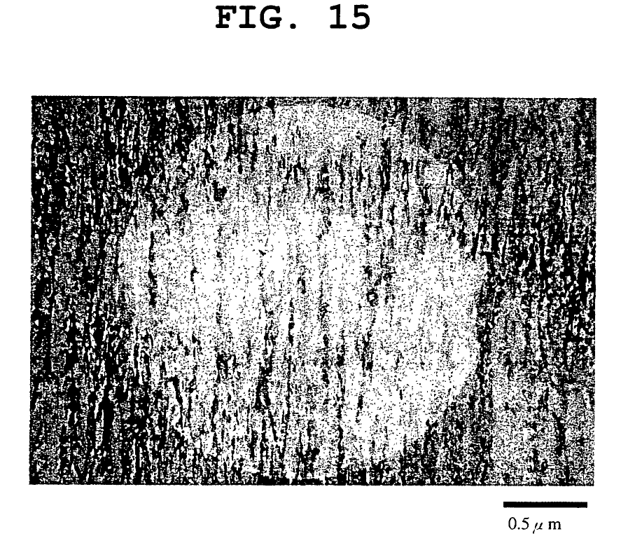

In region A, the jitter value is unfavorably high from the very 1st to about 5th DOW cycle as indicated by line 4 (●) in FIG. 14. Besides, the crystalline state as erased by overwriting gradually increases its reflectance with the DOW cycles to give a ΔR exceeding 10%. This is probably because the irradiated area of the recording layer does not reach the melting point and crystallizes in a solid phase. As a result, as shown in the TEM image of FIG. 15, needle-shape crystals do not grow sufficiently, leaving amorphous regions, notwithstanding their hexagonal crystal structure.

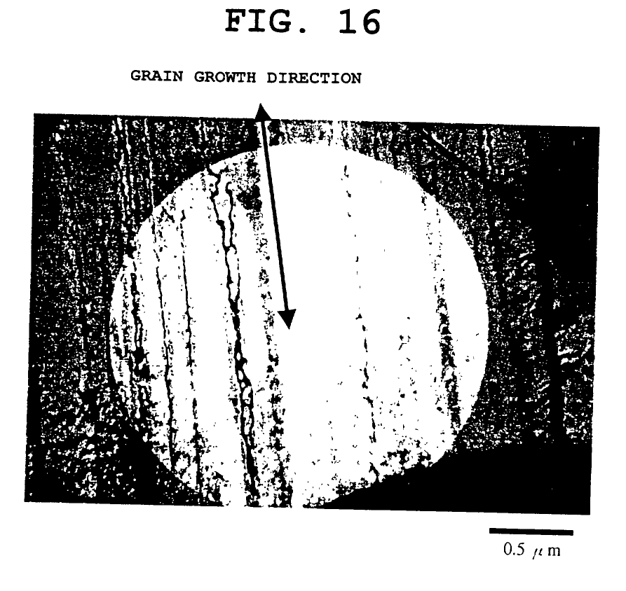

As the power density is raised, Ig increases discontinuously (transition region δR) and reaches a second plateau (region B). In transition region δR the reflectance varies in places, and Ig shows large variations in one round. In case of such large variations, average Ig values on several rounds are plotted in FIG. 13. In this region, jitter is very high from the very beginning and is not hardly reduced with DOW cycles on account of large variations in one round, as is indicated by line 3 (x) of FIG. 14. Strictly speaking, the plateau in region B shows a gentle ascent with power density. Although the crystal structure in region B is also hexagonal, the crystallites grow in the initializing beam scanning direction over a length of several tens of microns as shown in the TEM image of FIG. 16, failing to form desired columnar structures. Moreover, the TEM image shows little change in density attributable to internal orientation fluctuations. In region B. the 2θ of the peak for the (012) plane in the XRD pattern usually exceeds 28.85°. It is considered that strain due to orientation change accumulates in grain boundaries rather than inside the crystallites.

In region B, the recording layer is melted by the increased power density, and recrystallization occurs markedly because of the low linear velocity, growing grains formed by recrystallization on re-solidification seem to be linked without discontinuities according as the molten region moves. Further, crystal structures with small strain are formed probably because the cooling rate at each spot is relatively low. When a recording layer having such a polycrystalline structure is overwritten by mark length recording at a relatively low linear velocity, jitter dependence on DOW cycles is small as shown by line 7 (▴) in FIG. 14. However, when overwritten at a linear velocity about twice or more times the initializing beam scanning speed, the marks show an unusual increase of jitter. This situation is represented by line 5 (Δ) in FIG. 14, in which the jitter in the first writing after initialization (DOW 1 cycle) is on a satisfactory level but increases once in the first overwriting and then decreases as the DOW cycle number increases from 5 to 10. Such a jitter increase observed in the first DOW is designated a jitter bump.

In short, the crystalline state formed in region B at a low initialization linear velocity is unfavorable because of a noticeable jitter bump when overwritten at a high linear velocity. At a further increased power density (region C), film destruction or substrate deformation can occur.

Curve β of FIG. 13 represents the reflectance vs. power density relationship obtained when initialization is conducted at a scanning linear velocity within 20 to 80%, preferably 20 to 70%, and more preferably 20 to 60% of the maximum overwrite linear velocity. Curve β is similar to curve α in the way of changing; that is, region A (low reflectance) appears between straight lines dd′ and aa′ at a low powder density; transition region δR (discontinuous increase of reflectance with an increase of power) and then region B (high reflectance) appear between straight lines aa′ and bb′ and between straight lines bb′ and cc′, respectively, as the power is raised; and destruction region C follows. The difference is that, as the linear velocity increases, the discontinuity of the reflectance change in transition region δR becomes smaller and less clear, and the reflectance in region B becomes lower. In addition, a TED image of the crystalline state in region B of curve β more mainly comprises the pattern of FIG. 9A or 9B than that obtained in region A of the same curve. This means that the crystalline state obtained in region B assumes (012) plane orientation parallel to the recording layer plane more than that obtained in region A.

The crystalline state and its orientation in region B of curve β fall within preferred ranges of the invention. That is, the recording layer assumes a polycrystalline state having a substantially single phase composed of hexagonal needle-shape crystallites oriented in the same direction. As the initialization linear velocity increases, the reflectance (R1) in region B decreases thereby satisfying the relationship (1) (ΔR≦10%). This is in good agreement with a commonly observed phenomenon that a reflectance decreases with a decrease in grain size. In fact, the crystallites under TEM observation have smaller sizes, particularly in their longer axis direction.

When the above-described crystalline state is used as an initial non-recorded state on which data are overwritten, a jitter bump phenomenon can be suppressed as depicted by line 6 (□) in FIG. 14 over a low-to-high range of overwrite linear velocity.

The above-discussed observations can be summarized as follows. Of the initialized states specified by the initializing beam scanning speed and power in FIG. 13, region B wherein the linear velocity (scanning speed) falls within a range of 20 to 80%, preferably 20 to 70%, and more preferably 20 to 60% of the maximum possible linear velocity for overwriting provides a recording layer which can be used in the optical recording medium of the invention. Further, initialization at such a relatively high linear velocity makes it possible to create the same crystalline structure as an erased state obtained after high linear velocity overwriting and to suppress a jitter bump appearing in the initial stage of DOW cycles. This relationship between initialization conditions and the resultant crystalline state is common to recording media having the eutectic system recording layer according to the present invention protected with a heat-resistant protective layer on at least one side thereof. Even when initialization is carried out under the above-described conditions, a recording layer having an Sb/Te ratio of smaller than 3, particularly 70/30 (x/(1−x)=2.33) or smaller, is liable to generate face-centered cubic crystals like AgSbTe₂ (a-, b- and c-axis length: ca. 6 Å).

In order to prevent mixing of face-centered cubic crystals, the ratio x/(1−x) of SbₓTe₁₋ₓ is preferably equal to or greater than 3, which is equivalent to 0.75≦x, still preferably equal to or greater than 3.5, which is equivalent to 0.78≦x, particularly preferably equal to or greater than 4, which is equivalent to 0.8≦x. For 0.8≦x, the structure having main peak of (012) plane in XRD pattern can be easily obtained.

JP-A-1-303643 discloses a recording layer made of GeSbTe having a similar eutectic system composition, presenting an XRD pattern of Sb₈₀Te₂₀ (FIG. 1). However, only with three diffraction peaks in a low angle range up to 2θ=50° are not sufficient for distinguishing between a single phase and a mixed phase, still less between hexagonal structure and cubic structure.

Assuming that the crystal structure is a single phase hexagonal structure, the XRD pattern cannot be interpreted to indicate that the c-axis length or the (012) interplanar spacing are within the respective preferred ranges specified in the present invention. The details of initialization conditions used being unknown, it is still less conceivable that the recording layer may have an extremely useful polycrystalline structure in terms of preferred orientation, columner structure of grains and fine grain size with internal strain as a result of intentional manipulations for initialization control even if it has a single phase of hexagonal structure. Moreover, the recording system used in Examples is mark position recording, and there is no mention as to a jitter bump in the first overwrite cycle nor a suggestion for suppressing the jitter bump.

EP957476 (corresponding to JP-A-12-43415) teaches that an Ag—Sb—Te alloy having a similar eutectic system composition generates face-centered cubic structure. This is primarily because the alloy system mainly comprises a composition having an x/(1−x) ratio less than about 3 and conceivably because Ag is added. The present inventors have confirmed that the Sb/Te binary system having an Sb/Te ratio of 3 or smaller, particularly 2.33 (Sb/Te=70/30) or smaller, can generate cubic structure.

EP957476 has a mention that phase separation into an Sb phase and a Sb₂Te₃ phase occurs as the Sb/Te ratio increases over 3. However, a single phase hexagonal structure can be obtained without such phase separation as far as specific considerations are given to initialization as in the present invention, particularly where initial crystallization is carried out by melt initialization comprising irradiating with an energy beam at a high linear velocity. The technique of EP957476, in practice, seems to achieve stabilization of cubic structure by intentional addition of Ag or AgSbTe₂. In the present invention, on the other hand, Ag and Au are regarded as unfavorable dopant elements that may produce a mixed phase with cubic structure.

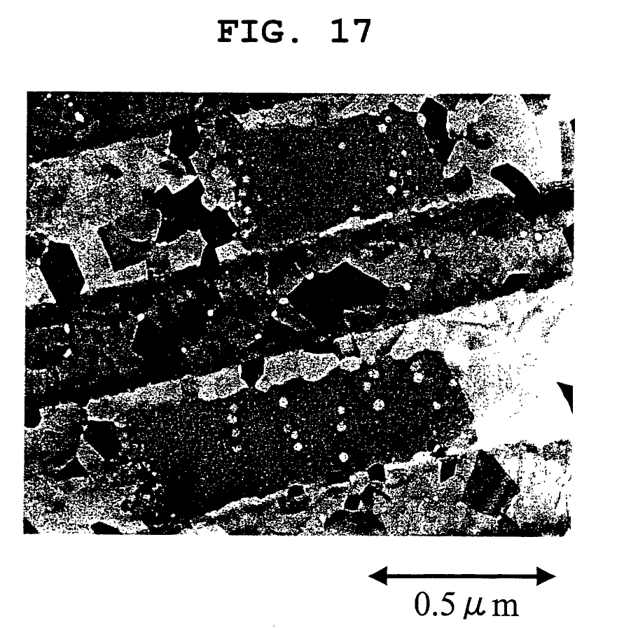

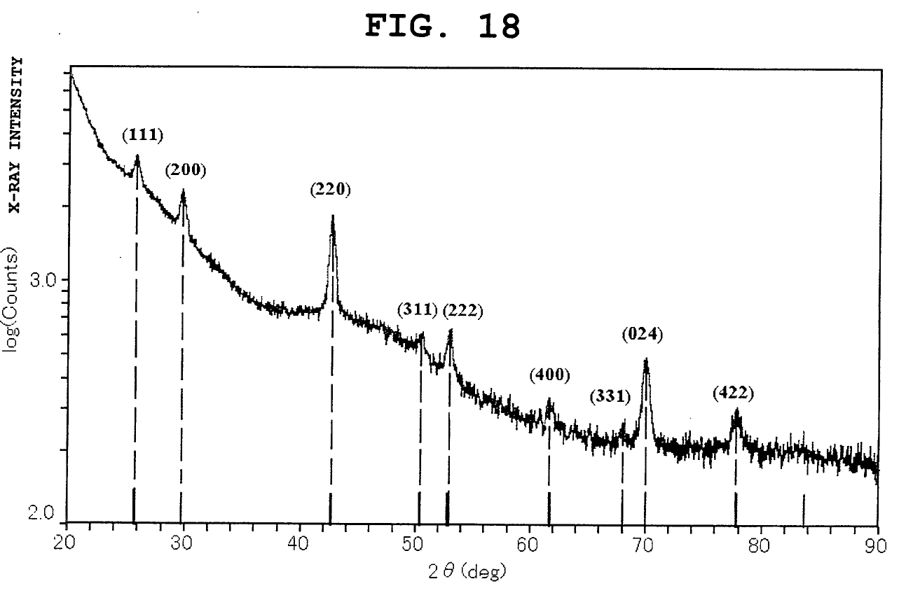

It is known that a GeTe—Sb₂Te₃ pseudo-binary recording layer, particularly Ge₂Sb₂Te₅ forms a single metastable phase composed of face-centered cubic structure after initialization or erasing. The problem of this type of recording layers is the presence of coarse crystal grains with clear boundaries as shown in FIG. 17, a TEM image of a Ge₂Sb₂Te₅ sample the present inventors had made. FIG. 18 is an XRD pattern of the sample measured according to a thin film XRD method, which agrees with the pattern of face-centered cubic structure having a lattice constant (a=b=c) of about 6 Å.

For practical application of the pseudo-binary system, manipulations such as addition of other elements are taken to reduce the grain size to 0.1 μm or smaller, which, on the other hand, results in increased grain boundaries. There is another problem that the individual crystallites have a rigid structure, accumulating the strain in their boundaries. In other words, even though the grain size is reduced, crystal growth controllability is confined to the level of a unit crystallite. Crystal growth around an amorphous mark cannot be controlled continuously particularly in the direction of the mark length.

The limit of crystal growth controllability means that mark length cannot be controlled continuously but discretely where a grain size approaches about 1/10 of a mark size. The failure of control leads to increased jitter at mark edges and difficulty in reducing the jitter to a satisfactory level. This is a fatal problem in achieving high-density recording.

As in the present invention, it is more effective for jitter reduction to reduce the amount of grain boundaries while retaining some grain size and to make the individual crystal structures flexible and grow in the same direction along the mark length direction thereby reducing the strain in the boundaries and enabling continuous mark length control.

Closest-packing structures include a cubic one and a hexagonal one. A hexagonal closest-packing structure has a layer structure having relative freedom in the way of stacking. Therefore, as we believe, a choice of hexagonal structure brings about flexibility of the crystal structure, which will give the benefit of free control on crystal growth simply by making a temperature change in a specific direction.

A recording layer having a composition near Ge₂Sb₂Te₅, while relatively slow in crystal growth, accomplishes recrystallization by filling the entire amorphous region with an increased number of crystal grains. That is, a GeTe—Sb₂Te₃ pseud-binary alloy system recording layer achieves high-speed crystallization in high linear velocity erasing by accelerating nucleation. However, since the nucleation rate reaches the maximum at a much lower temperature than the melting point as compared with crystal growth so that nucleation gradually proceeds at relatively low temperatures to form small grains, from which recrystallization proceeds gradually even around room temperature.

WO 00/72316 discloses a crystalline state which is similar to that of the recording layer used in the present invention. With no particular manipulations for initial crystallization, the technique disclosed fails to provide a specific initial polycrystalline structure as aimed at in the present invention after initial crystallization. Thus, the present invention produces a unique effect not heretofore attained. The invention provides an optical recording medium with markedly reduced signal noise and excellent jitter characteristics by controlling an initial crystallization operation in such a manner that the crystalline state after initialization is equalized to the crystalline phase after erasing with a focused light beam.

Other particulars for practically applying the optical recording medium according to the invention will be described briefly.

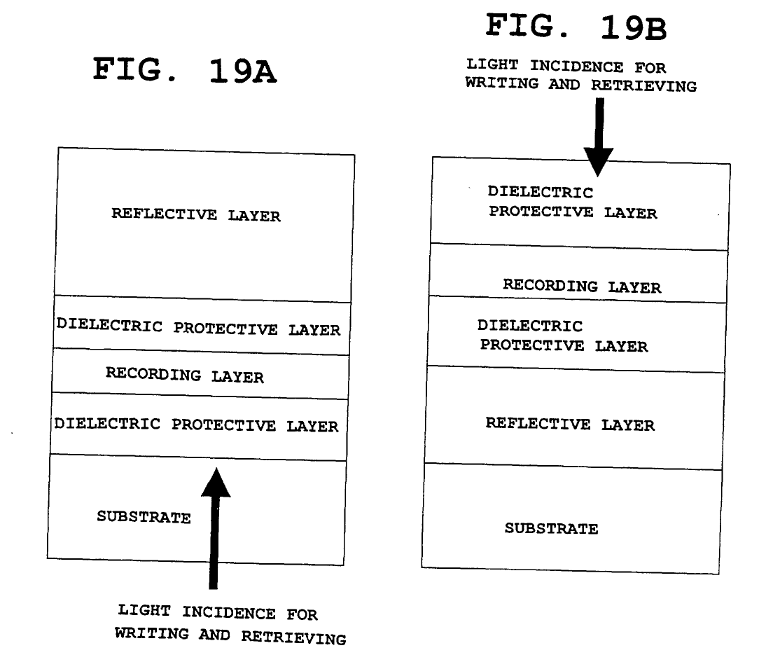

The recording medium usually has a multi-layer structure as shown in FIG. 19A or 19B. The recording medium preferably has a heat-resistant dielectric protective layer on both sides of the recording layer. While not essential, a reflective layer is provided on the side opposite to a write/retrieve light beam incident side. If desired, a semi-transparent light-absorbing layer can be provided on the light incident side. If necessary, the protective layer may be composed of a plurality of films made of different materials with different characteristics.

The recording layer usually has a thickness of 1 nm or more, preferably 5 nm or more, still preferably 10 nm or more, and usually has a thickness of 30 nm or less, preferably 25 nm or less, still preferably 20 nm or less. Too thin a recording layer may fail to produce a sufficient reflectance contrast between a crystalline state and an amorphous state and tends to have a low crystallization rate, having difficulty in accomplishing writing and erasing in a short time. Additionally, the reflectance tends to be too low.

With too large a recording layer thickness, a sufficient optical contrast is difficult to produce, and cracks tend to develop. Further, the heat capacity tends to increase to deteriorate recording sensitivity. Furthermore, too thick a recording layer undergoes appreciable volume change with phase transition. It tends to follow that irreversible microscopic deformation is accumulated in the recording layer itself and the upper and lower protective layers with repetition of overwriting to cause noise. As a result, durability against repeated overwriting may be reduced. In view of the strict demand for low noise of high-density media such as rewritable DVDs, the thickness of the recording layer for such applications is preferably 20 nm or smaller.

The recording layer can be obtained by DC or RF sputtering in an inert gas, particularly argon gas, by using an alloy target having a prescribed composition. The recording layer has a film density usually of 80% or more, preferably 90% or more, of the bulk density. The “bulk density ρ” is customarily an approximate value calculated from equation (2) shown below, or can be measured on an experimentally prepared ingot.

ρ=Σmᵢρᵢ (2)

wherein mᵢ is a molar concentration of element i; and ρᵢ is an atomic weight of element i)

A recording layer with an increased density can be obtained by increasing the amount of high-energy gas to be struck against the growing film. For example, in order to increase the amount of high-energy gas, the pressure of a sputtering gas (usually a rare gas, e.g., Ar, which will be specifically referred to in the following description) in film formation is reduced, or the substrate is placed close to and in front of the target. The high-energy Ar gas is a part of Ar ions that strike against the target and bounce onto the substrate or Ar ions in a plasma which are accelerated by the sheath voltage on the entire surface of the substrate and arrive at the substrate.

The above-mentioned effect of high-energy rare gas is called an atomic peening effect. In sputtering in an argon gas commonly employed, Ar is implanted into the sputtered film by the atomic peening effect. The atomic peening effect can be estimated from the amount of Ar in the sputtered film. A small Ar amount is an evidence showing a small effect of the high-energy Ar, which tends to result in a less dense film.

A large amount of Ar in the film means that high-energy Ar has been applied vigorously to form a denser film. However, a large Ar amount tends to deteriorate durability against repeated overwriting because the implanted Ar is apt to precipitate on repeating overwriting, leaving voids in the film. Hence a suitable amount of Ar in the recording layer is 0.1 atom % or more and less than 1.5 atom %. RF sputtering is preferred to DC sputtering for obtaining a denser film with a smaller amount of Ar.

Elements other than the recording layer which make up the optical recording medium of the invention are then described.

Materials of the substrate which can be used in the invention include transparent resins, such as polycarbonate, acrylic resins, and polyolefins, glass, and metals, such as aluminum. Considering that a substrate is usually provided with guiding grooves having a depth of about 10 to 80 nm, resins that are easy to mold into a grooved substrate are preferred.

The protective layer, which is provided on one side or both sides of the recording layer, is for preventing evaporation and deformation of the recording layer which accompany phase changes of the recording layer and also for controlling heat diffusion accompanying phase changes. The material making the protective layer(s) is decided taking into consideration refractive index, thermal conductivity, chemical stability, mechanical strength, adhesion, and so forth and is generally selected from those dielectrics which have high transparency and high melting points; for example, oxides, sulfides, nitrides or carbides of metals or semiconductors and fluorides of Ca, Mg, Li, etc.

The oxides, sulfides, nitrides, carbides or fluorides do not always need to have a stoichiometric composition. It is effective for obtaining a controlled refractive index, etc. to adjust the composition or to mix compositions. Mixtures of dielectrics are preferred from the standpoint of repeated overwriting characteristics. More specifically, mixtures of a chalcogenide, such as ZnS and a rare earth element sulfide, and a heat-resistant compound, such as oxides, nitrides, carbides, and fluorides, are useful. A mixture of heat-resistant compounds which mainly comprises ZnS and a mixture of heat-resistant compounds which mainly comprises a sulfide of a rare earth element, e.g., Y₂O₂S, are preferred examples of the protective layer composition.

From the standpoint of mechanical strength withstanding repeated overwriting, the protective layers preferably have a film density of 80% or more of the bulk density. In using a mixture of dielectrics, the theoretical density according to equation (2) is used as a “bulk density”, where ρᵢ is referred to the density of individual dielectric material and m: is referred to the molar fraction of individual dielectric material in the mixed compounds.

The protective layers preferably have a thickness of 1 nm or greater to prevent deformation of the recording layer and the substrate. The thickness of the protective layers is preferably not greater than 500 nm so as to minimize the internal stress of the dielectric protective layers and the difference in elastic characteristics from the substrate thereby inhibiting crack development.

More specifically, the lower protective layer (the protective layer between the recording layer and the substrate on the read/write light beam entrance side) usually has a thickness of 1 nm or greater, preferably 5 nm or greater, still preferably 10 nm or greater, so as to suppress thermal deformation of the substrate. If the lower protective layer is too thin, microscopic deformation of the substrate occurring in repeated overwriting will be accumulated, and retrieve light may be scattered, resulting in a noticeable increase of noise. From the standpoint of productivity in film formation, the thickness of the lower protective layer is usually 200 nm or smaller, preferably 150 nm or smaller, still preferably 100 nm or smaller.

If the thickness of the lower protective layer is too large, the surface of the recording layer cannot reflect the groove configuration of the substrate such as the depth or width of the grooves.

The upper protective layer (the protective layer on the recording layer opposite side of the read/write light beam entrance side.), if provided, usually has a thickness of 1 nm or greater, preferably 5 nm or greater, still preferably 10 nm or greater, for suppressing deformation of the underlying recording layer. If the upper protective layer is too thick, microscopic plastic deformation will be accumulated inside the upper protective layer, and retrieve light may be scattered, resulting in a noticeable increase of noise. The thickness of the upper protective layer is usually 200 nm or smaller, preferably 150 nm or smaller, still preferably 100 nm or smaller, particularly preferably 50 nm or smaller.

The thicknesses of the recording layer and the protective layer(s) should be decided taking into consideration mechanical strength, reliability, and the interference effect accompanying a multi-layer structure so as to secure good laser light absorption efficiency and to provide a high amplitude of recording signals, i.e., high contract between a recorded state and a non-recorded state.

The phase-change type optical recording medium of the invention can further have a reflective layer. The position of the reflective layer usually depends on the incidence direction of retrieve light. The reflective layer is provided on the side of the recording layer opposite to the light incidence side. That is, where retrieve light is incident on the substrate side, it is usually provided farther from the substrate than the recording layer. Where retrieve light is incident on the recording layer side, it is usually provided between the recording layer and the substrate (see FIGS. 19A and 19B).

The reflective layer is preferably made of a material having a high reflectance, particularly a metal such as Au, Ag or Al of which a heat dissipation effect is expected. Heat dissipating properties of the reflective layer depend on the film thickness and the thermal conductivity of the material. Seeing that the thermal conductivity of these metals is nearly in inverse proportion to its volume resistivity, it is preferred for the reflective layer to have a sheet resistivity of 0.2 to 0.6 Ω/□, particularly 0.2 to 0.5 Ω/□, to assure a particularly high heat dissipation effect. Where amorphous mark formation involves remarkable competition between amorphization and recrystallization as in the recording layer used in the invention, such a high heat dissipation effect is required in order to suppress recrystallization to some extent.

For the purpose of controlling thermal conductivity of the reflective layer itself or for improvement of anticorrosion, Ta, Ti, Cr, Mo, Mg, V, Nb, Zr, Si, etc. may be added to the above-described metal in an amount usually of about 0.01 to 20 atom %. An aluminum alloy containing 15 atom % or less of Ta and/or Ti, particularly AlₓTa₁₋ₓ (0<x<0.15) is a particularly preferred material for improving the reliability of the medium because of its excellent anticorrosion. A silver alloy containing 0.01 to 10 atom % of at least one of Mg, Ti, Au, Cu, Pd, Pt, Zn, Cr, Si, Ge, and rare earth elements is also preferred for its high thermal conductivity and heat resistance.

The reflective layer preferably has a thickness of at least 10 nm to prevent light transmission and completely reflect incident light. An excessive thickness produces no further heat dissipation effect only to reduce productivity and can result in crack development. The upper limit of the thickness is usually 500 nm. With a thickness ranging from 40 to 50 nm, it is advisable that the amount of unnecessary impurities such as oxygen and so on be less than 2 atom % so as to assure a high thermal conductivity.

A preferred layer structure of the recording medium comprises a stack of a first protective layer, a recording layer, a second protective layer, and a reflective layer in this order from the light incidence side. Specifically, the medium preferably has a layer order of substrate/lower protective layer/recording layer/upper protective layer/reflective layer which receives retrieve light on its substrate side (substrate incidence type shown in FIG. 19A) and a layer order of substrate/reflective layer/lower protective layer/recording layer/upper protective layer which receives retrieve light on the recording layer side (film-side incidence type shown in FIG. 19B).

Each of the constituent layers may be composed of two or more films. An intermediate layer may be provided between the layers. For example, a very thin semi-transparent layer made of a metal, a semiconductor or a light-absorbing dielectric can be provided between the substrate and the lower protective layer (in the case of a substrate incidence type) or on the upper protective layer (in the case of a film-side incidence type) to control the light energy quantity entering the recording layer.

The recording layer, the protective layer, and the reflective layer are usually formed by sputtering or a like technique. Film formation by sputtering is preferably carried out by means of an in-line system having the respective sputtering targets for these layers in the same vacuum chamber. This is advantageous for preventing oxidation or contamination from occurring between layers. It is also superior from the aspect of productivity.

A protective coat made of an ultraviolet-curing resin or a thermosetting resin is preferably provided on the outermost layer to protect from direct contact with air or scratches by contact with foreign matter. The protective coat usually has a thickness of 1 μm to several hundreds of microns. A hard dielectric protective layer may be provided, and a resin layer may further be provided thereon.

The optical recording medium of the invention is preferably produced by a process according to the present invention. That is, the invention also provides a preferred process of producing an optical recording medium which comprises (1) a first protective layer having a thickness of 10 to 100 nm, (2) a recording layer having a thickness of 1 to 20 nm, mainly comprising a composition represented by formula: SbₓTe₁₋ₓ (0.75≦x≦0.9) and showing reversible phase changes on light beam irradiation between a crystalline state and an amorphous state differing from each other in optical properties, (3) a second protective layer having a thickness of 1 to 50 nm, and (4) a reflective layer having a sheet resistivity of 0.2 to 0.6 Ω/□ in this order, has a reflectance of 15 to 25% when retrieving light is incident on said recording layer from the side of first protective layer, and has maximum possible overwriting linear velocity of at least 15 m/sec or more, the process comprising forming at least the recording layer on a substrate and crystallizing the recording layer for initialization by scanning with an elliptic light beam having a wavelength of 750 to 850 nm and a minor axis length of 1 to 2 μm in the direction agreeing with the minor axis direction of the elliptic light beam at a linear velocity of 5 to 15 m/sec and within 20 to 60% of the maximum possible overwriting linear velocity, wherein the power density of the elliptic light beam divided by the linear velocity of the elliptic light beam is in a range of from 0.85 to 1.2 mW·s/(pm²·m).

Write/retrieve light which can be used for the recording medium of the invention is usually a laser beam of a semiconductor laser or a gas laser usually having a wavelength of about 300 to 800 nm, preferably 350 to 800 nm. It is necessary to reduce the beam diameter to achieve a high planar recording density, particularly of 1 Gbit/inch² or higher. A preferred focused light beam is one obtained by using blue to red laser light having a wavelength of 350 to 680 nm and an objective lens having a numerical aperture (NA) of 0.5 or greater.

In the present invention, recording is commonly carried out by using the amorphous state as a recorded mark. The present invention is effective in mark-length modulation recording, especially in mark length recording making amorphous marks the shortest length of which is 1 μm or less, particularly 0.4 μm or less. The effects of the invention are not so noticeably manifested in mark position recording or where mark lengths are very long because such recording systems essentially promise sufficient recording characteristics to some extent.

While the medium of the present invention is excellent when applied to conventional two levels of writing power, it is particularly effective when applied to multi-level (over three levels) of writing power according to a divided pulse recording system which makes “off-pulse” sections in mark formation as hereinafter described.

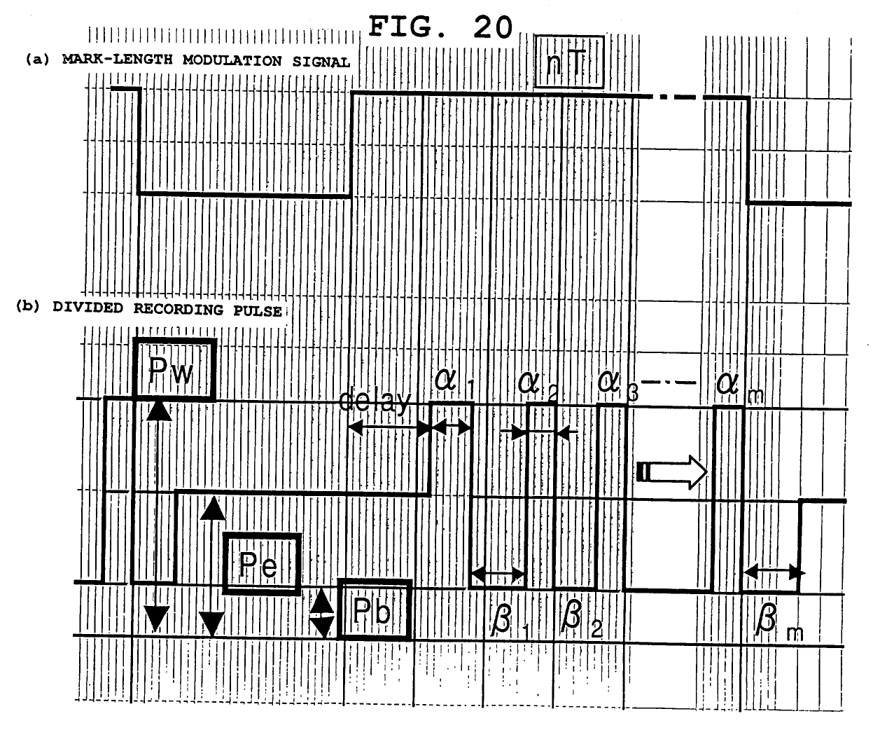

FIG. 20 schematically shows a power pattern of writing light according to the above-described write strategy. For forming an amorphous mark modulated to a length nT (T: reference clock period; n: an integer, a mark length possible in mark-length modulation recording), a time (n−j)T (j: a real number of 0 to 2) is divided into m pulses (m=n−k; k: an integer of 0 to 2) so that each writing pulse section represented by αᵢT (1≦i≦m) is followed by an off-pulse section represented by βᵢT (1≦i≦m). αᵢ is preferably equal to or smaller than βᵢ, or αis preferably equal to or smaller than βᵢ₋₁ (2≦i≦m or m−1). Σαᵢ+Σβᵢ, which is usually equal to n, may be n−j (j: a constant of −2 to 2) for obtaining an accurate nT mark.

In recording, areas between marks are irradiated with recording light having an erase power Pe capable of crystallizing an amorphous region. The sections αᵢT (1≦i≦m) are irradiated with a writing light beam having a write power Pw sufficient for melting the irradiated area, and the sections βᵢT (1≦i≦m−1) are irradiated with a writing light beam having a bias power Pb which is smaller than Pe and preferably equal to or smaller than (½)Pe.

The bias power Pb to be applied to the section βₘT is usually smaller than Pe, preferably equal to or smaller than (½)Pe, similarly to the sections βᵢT (1≦i≦m−1) but may be equal to Pe.

By this strategy, a power margin or a recording linear velocity margin can be broadened, which effect is conspicuous where the bias power Pb is made sufficiently low to satisfy the relationship: Pb≦½Pe.

The advantage of the divided pulse recording system is pronouncedly manifested in using a phase-change type optical recording medium using the eutectic system recording layer according to the present invention for the following reasons. Erasing of amorphous marks, i.e., recrystallization is substantially governed by only the crystal growth starting from the boundaries between the amorphous marks and the surrounding crystalline region. Nucleation within amorphous marks and resultant crystal growth from the crystal nuclei make little contribution to the recrystallization process. According as the amount of excess of Sb is increased in an attempt to ensure erasing in a short time, the critical cooling rate necessary for amorphous mark formation will become extremely high, resulting in difficulty in forming satisfactory amorphous marks. This is because an increase of Sb not only accelerates recrystallization from the surrounding crystalline region but also increases the crystal growth rate in a melt/re-solidification process. If the rate of recrystallization from the surrounding crystalline region is increased above a certain level, recrystallization from the periphery of a molten region will proceed while a molten region formed for amorphous mark formation is re-solidified, and the molten region tends to recrystallize without amorphization unless the cooling rate is extremely high.

Besides, the crock period will be shortened, and the off-pulse sections become shorter accordingly to impair the cooling effect. Therefore, it is effective to divide an nT mark, setting the cooling time by an off-pulse at 1 nsec or longer, particularly 3 nsec or longer.

The present invention will now be illustrated in greater detail with reference to Examples, but the present invention is not construed as being limited thereto unless modifications depart from the spirit and scope of the present invention.

Unless otherwise noted, the optical recording media were prepared by successively depositing, in the order described, a first protective layer of ZnS:SiO₂ (80:20 by mol %) having a thickness of 60 to 100 nm, a recording layer having a thickness of 11 to 15 nm, a second protective layer of ZnS: SiO₂ (80:20 by mol %) having a thickness of 20 to 40 nm, and an aluminum alloy reflective layer having a thickness of 100 to 200 nm (sheet resistivity: about 0.45 Ω/□) by sputtering on a polycarbonate substrate in an argon atmosphere and forming a protective coat of an ultraviolet-curing resin having a thickness of about 5 μm on the reflective layer by spin coating and UV curing.

The recording layer composition had been corrected based on the X-ray intensity of each element as determined by X-ray fluorescence analysis and an absolute composition as determined by chemical analysis (atomic absorption spectroscopy). It was usually obtained by X-ray fluorescence analysis. Unless otherwise specified, initial crystallization was carried out by scanning a disc rotating at a prescribed linear speed with an elliptic focused light beam having a wavelength of about 810 nm, a major axis length of about 130 μm, and a minor axis length of about 1 μm with its major axis agreeing with the radial direction of the disc. The beam was moved in the radial direction at a pitch of 60 μm per round.

Since an initialization apparatus involves a loss of laser light power from an optical system, the power actually applied onto an optical recording medium should be re-calculated. The power of laser light actually applied is calculated by using a power efficiency, which is obtained by subtracting the power loss value from 1. The actual power is obtained by multiplying the power of laser light by the power efficiency and dividing the product by the area of the beam profile (an area obtained by multiplying the major axis length by the minor axis length is used for convenience). The power efficiency, a reduced value, varies depending on the optical system of initial crystallization apparatus. It was “0.65” in Examples 1 to 4 and Comparative Examples 1 to 4 and “1” in Comparative Examples 6 and 7. Afterwards only the actual power is referred as initialization light power.

Disc characteristics and reflectance (retrieved light output: Ig) were measured by means of an optical disc tester DDU1000, supplied by Pulstec Industrial Co., Ltd. , by scanning the recording layer with a retrieve power Pr less than 1 mW with focus servo and tracking servo applied to grooves.

XRD patterns were measured by a thin film XRD method using a sample prepared by stripping the protective coat side of a disc-shaped medium using an adhesive tape to expose the interface between the recording layer and the upper protective layer. The sample was set in an XRD apparatus RINK1500, supplied by Rigaku Corp., having an optical system exclusive for thin film containing two soller slits as shown in FIG. 3, and an XRD pattern was measured at an incidence angle α of 0.5°. The goniometer of the apparatus has a radius of 185 mm. In FIG. 3, the incidence angle α of X-rays on the sample surface was as small as 0.5° so that the influences of diffraction/scatter from the polycarbonate substrate might be minimized.

CuKα radiation (Kα X-rays from copper) was used as an X-ray source. Other conditions for XRD were as follows. Tube voltage: 50 kV; tube current: 200 mTA; incident slit: 0.4 mm; vertical divergence-limiting soller slit: 8 mm; horizontal divergence-limiting soller slit: 8 mm; receiving slit: 0.8 mm; graphite monochromator; sampling width: 0.050; scanning speed: 3°/min; and mode of measurement: continuous scan. The disc with the recording layer exposed was rotated on its own axis at 120 rpm.

Further, the sample was subjected to precise measurement in a step scan mode under conditions of 2θ=26 to 31°; incident slit: 0.2 mm; sampling width: 0.010°; and count time: 3 sec. The half-value width of the predominant peak with only CuKα1 radiation is calculated from the resulting peak profile according to profile fitting procedures using pseudo-Voigt functions. A linear function was used for the background.

TEM observation and measurement were carried out as follows. A sample was prepared by stripping the protective coat side of a disc medium using an adhesive tape to expose the recording layer surface, sputtering ZnS:SiO₂ (80:20 by mol %) on the exposed recording layer to a deposit thickness of 1 nm, removing the substrate by mechanical abrasion and dissolution with a solvent, and sandwiching the resulting stack of layers between two pieces of Cu mesh. The sample was photographed under a TEM H-9000NA, supplied by Hitachi, Ltd. at an accelerated voltage of 300 kV. A TED image was obtained by a selected area electron diffraction method under conditions of a camera length of 1 m and an electron beam diameter of about 0.4 μm so as to give a diffraction pattern of a single crystallite.

### EXAMPLES 1 TO 3 AND COMPARATIVE EXAMPLES 1 TO 4

Rewritable compact discs having the above-described layer structure were prepared using a polycarbonate resin substrate having a diameter of 120 mm and a thickness of 1.2 mm and a recording layer composition of In₃Ge₅Sb₇₁Te₂₁ (atom %). The substrate used had a spiral groove for tracking having a groove depth of about 35 nm and a width of 0.55 μm at a pitch of 1.6 μm formed by injection molding. The discs had a reflectance of about 18% in an erased region. The maximum linear velocity for overwriting was about 15 m/sec. At overwriting velocity of 15 m/sec, over 20 dB erasure ratio was obtained for the carrier level in 3T mark and space repeated pattern signal, where clock period T was about 19 nsec.

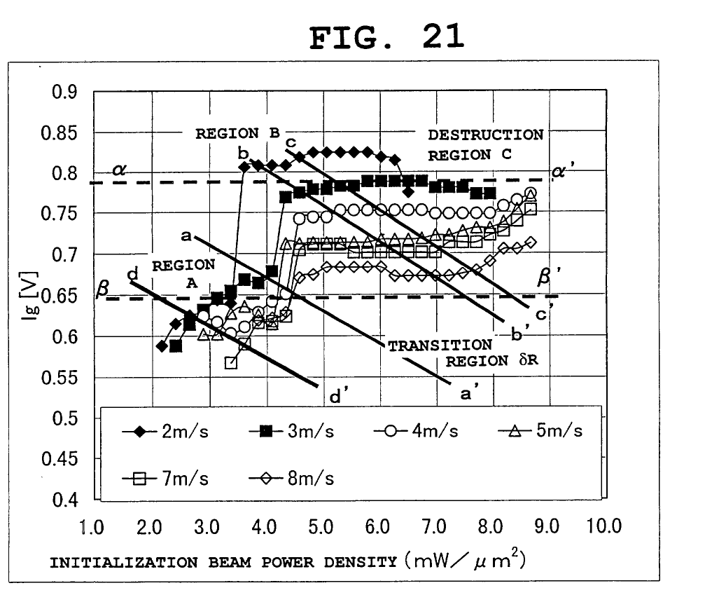

The discs were initialized under varied conditions, and the reflectance (retrieved light output Ig (V)) in the initialized state was plotted against the actual initializing beam power density (initializing power density) and the initializing beam scanning speed (initializing linear velocity). FIG. 21 is a graph representing the dependency of the initial reflectance Ig on the initializing power density and the initializing linear velocity in a range of from 2 to 8 m/sec. At scanning speeds of 9 m/sec or higher, crystallization was incomplete due to amorphization. The retrieved light output after 10 DOW cycles was 0.72 V, which corresponds to reflectance R2 of about 18%. The relationship between R1 and R2 as defined by equation (1) was satisfied in the range between dotted lines αα′ and ββ′ in the graph of FIG. 21.

The plots of Ig of FIG. 21 can be divided into regions A, δR, B, and C as described with reference to FIG. 13. Crystalline structures preferred in the present invention were obtained within an initializing linear velocity range of about 4 to 8.5 m/sec, which corresponded to 27 to 57% of the maximum possible linear velocity for overwriting (15 m/sec). Data obtained in Examples 1 to 4 and Comparative Examples 1 to 3, the initialization conditions of which are shown in Table 1 below, were as follows. All the crystal structures resulting from initialization were found to have a single phase hexagonal. The XRD pattern of every recording layer showed a predominant peak representing a (012) plane. The crystalline structure, the peak position for the (012) plane, the a-axis and c-axis lengths, and the half-value width of the peak for the (012) plane by only CuKα1 radiation are shown in Table 1. The crystalline structure was decided from similarity to any one of the TEM images of FIGS. 10, 15, and 16. Of the cryallites all those having a crystalline structure of FIG. 10 had a width of about 0.2 μm or smaller.

TABLE 1

| | | | Ini- | | | | | | | | | |
|---|---|---|---|---|---|---|---|---|---|---|---|---|
| | Ini- | | tial- | | | | | | | | | |
| | tial- | Ini- | ization | | | | | | Jitter | | | |
| | izing | tial- | Power | | | | | | in 1st | | | |
| | Lin- | izing | Density/ | | Posi- | | | | Record- | | | |
| | ear | Power | Initial- | | tion | | | | ing on | Jitter in | | |
| | Veloc- | Den- | ization | | of | | | | Non- | 1st | | Half- |
| | ity | sity | Linear | | (012) | a-Axis | c-Axis | Crystal- | Recorded | Overwrit- | | value |
| | (m/- | (mW/- | Veloc- | Region | Peak | Length | Length | lite | State | ing | ΔR | Width |
| | sec) | μm²) | ity | of Ig | (°) | (Å) | (Å) | Structure | (nsec) | (nsec) | (%) | (°) |
| Ex. 1 | 4 | 5.5 | 1.38 | B | 28.82 | 4.322 | 11.025 | | 22 | 33 | 8 | 0.721 |
| | | | | | | | | (needle- | | | | |
| | | | | | | | | shape) | | | | |
| Ex. 2 | 7 | 6.5 | 0.93 | B | 28.83 | 4.317 | 11.002 | | 23 | 25 | 5 | 0.722 |
| | | | | | | | | (needle- | | | | |
| | | | | | | | | shape) | | | | |
| Ex. 3 | 7 | 7.2 | 1.03 | B | 28.82 | 4.327 | 11.027 | | 24 | 24 | 7 | 0.738 |
| | | | | | | | | (needle- | | | | |
| | | | | | | | | shape) | | | | |
| Comp. | 4 | 3 | 0.75 | A | 28.85 | 4.324 | 11.048 | | 25 | 37 | 15 | 0.698 |
| Ex. 1 | | | | | | | | | | | | |
| Comp. | 7 | 4 | 0.57 | A | 28.82 | 4.324 | 10.974 | | 30 | 39 | 20 | 0.712 |
| Ex. 2 | | | | | | | | | | | | |
| Comp. | 2 | 4.3 | 2.15 | B | 28.87 | 4.315 | 11.026 | | 18 | 45 | 8 | 0.698 |
| Ex. 3 | | | | | | | | | | | | |
| Comp. | 2 | 3 | 1.5 | A | 28.91 | 4.301 | 11.035 | | 28 | 40 | 20 | 0.689 |
| Ex. 4 | | | | | | | | | | | | |

It is seen that the peak position for the (012) plane is larger than 28.85° at a low linear velocity of about 3 m/sec or lower and that needle-shape crystal growth in the same direction is not observed in region A (low initializing power, low reflectance).

These discs were recorded by using an optical disc tester DDU1000 (wavelength: about 780 nm; NA: 0.5) according to an EFM modulation system for clock period T, which is a mark-length modulation recording system interchangeable with CDs containing 9 mark lengths from 3T to 11T and mark spacings. The clock period T was set at 231 nsec at a CD standard linear velocity 1.2 m/sec, and the linear velocity in retrieving was 1.2 m/sec. In writing, the linear velocity was 12 times the retrieve linear velocity, i.e., 12 m/sec, and the clock period T was 1/10, i.e., 23.1 nsec.

The discs were repeatedly overwritten by a divided pulse recording system in which an nT mark is divided into (n−1) writing pulse sections (Pw irradiation) and off-pulse sections (Pb irradiation) in accordance with Orange Book Part 3 (standards covering CD-RWs) using a write powder Pw of about 20 mW, an erase power Pe of about 9 mW, and a bias power Pb of 0.8 mW. As a jitter value, 3T mark length jitter was measured. The upper acceptable jitter limit is 35 nsec according to the CD standards. The overwrite characteristics of the discs are shown in Table 1.

In Examples 1 to 3, ΔR of relationship (1) was 10% or less. The jitter was satisfactorily suppressed in both the first writing and the first overwriting even when the overwriting linear velocity was as high as 12 m/sec which is close to the maximum overwrite linear velocity.

### EXAMPLE 4

An optical disc was prepared in the same manner as in Example 1, except for using Ge₅Sb₇₉Te₁₆ as a recording layer composition. The maximum overwrite linear velocity was 24 m/sec which approximately corresponds to 20 times the CD linear velocity. The disc was initialized at a beam scanning speed of 8 to 10 m/sec at a power density of 8.67 mW/μm² (0.87-1.1 mW·s/(μm²·m)) to produce an initialized crystalline state of a single phase composed of hexagonal crystals which exhibited a predominant peak representing a (012) plane in thin film XRD. TEM observation revealed needle-shape crystallites having grown almost in the same direction along the initializing beam scanning direction.

The disc was repeatedly overwritten by a divided pulse recording system in which an nT mark was divided into n/2 (a fraction was omitted) writing pulse sections (Pw=about 20 W) and n/2 off-pulse sections (Pb=0.8 mW) at a recording speed of 19.2 m/sec. The 3T mark length jitter was 35 nsec or less in all of first writing and first to tenth overwriting, indicating satisfactory overwritability. ΔR of relationship (1) was 10% or smaller.

### COMPARATIVE EXAMPLE 5

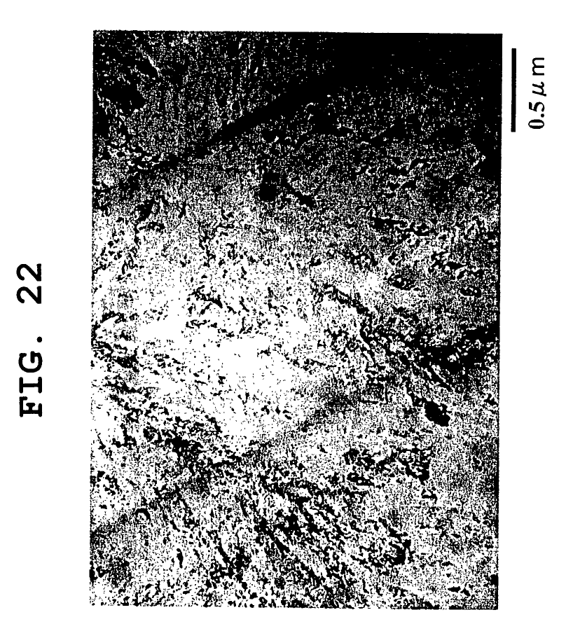

An optical disc was prepared in the same manner as in Example 1. The entire surface of the disc was initialized by pulsated light of a xenon flash lamp at a pulse width less than 10 msec while the disc was fixed. The reflectance of the non-recorded state after initialization was low to give ΔR of 20% in relationship (1). If the irradiation power had been increased to a level that could melt the recording layer in an attempt to increase the reflectance in the post-initiation non-recorded state, the recording layer would have undergone considerable film destruction because of the large irradiation area. Therefore, there was no way but solid phase crystallization with a low power to accomplish initialization. A TEM image of the recording layer after initialization is shown in FIG. 22. No preferential growth of needle-shape crystallites in a specific direction was observed. Additionally, a halo pattern appeared in TED of the initialized recording layer, suggesting remaining of an amorphous region.

When the disc was overwritten at a linear velocity of 12 m/sec in the same manner as in Example 1, the jitter bump was 40 nsec or more.

### COMPARATIVE EXAMPLE 6

On a polycarbonate disc substrate having a thickness of 1.2 mm and a spiral tracking groove (pitch: 1.6 μm; width: about 0.53 μm; depth: about 37 nm) were formed a 97 nm-thick (ZnS)₈₀(SiO₂)₂₀ protective layer, a 20 nm-thick Ge₆Sb₇₇Te₁₇ recording layer, a 40 nm-thick (ZnS) ₈₅ (SiO₂)₁₅ protective layer, and a 250 nm-thick Al_{99.5}Ta_{0.5} reflective layer by sputtering in respective vacuum chambers. An ultraviolet-curing resin was applied on the reflective layer to a thickness of 4 μm and cured to form a protective coat. The maximum possible overwriting linear velocity was about 24 m/sec.

The resulting phase change type rewritable disc was initialized with an elliptic laser beam having a wavelength of 810 nm, a major axis length of about 108 μm, and a minor axis length of 1.5 μm at a beam scanning speed of 4 m/sec and a power of 420 mW (initializing power density: 2.6 mW/μm², 0.65 mW·s/(μm²·m)). The ΔR of the medium was 14%, which indicates that the above-described initialization conditions failed to create the specific hexagonal structure according to the invention. That is, the initialization conditions adopted here only provide an optical recording medium of high noise unfit for practical use.

### COMPARATIVE EXAMPLE 7

On a polycarbonate disc substrate having a thickness of 1.2 mm and a spiral tracking groove (pitch: 1.6 μm; width: about 0.53 μm; depth: about 37 nm) were formed a 70 nm-thick (ZnS)₈₀(SiO₂)₂₀ protective layer, a 17 nm-thick Ge₇Sb₇₈Te₁₅ recording layer, a 45 nm-thick (ZnS)₈₀ (SiO₂) ₂₀ protective layer, and a 220 nm-thick Al_{99.5}Ta_{0.5} reflective layer (volume resistivity: about 100 nΩ·m; sheet resistivity: 0.45 Ω/□) by sputtering in respective vacuum chambers. An ultraviolet-curing resin was applied on the reflective layer to a thickness of 4 μm and cured to form a protective coat. The spiral tracking groove was “wobbled” in a sinusoidal fashion with an amplitude of 30 nm and a frequency of 22.05 kHz with a deviation of ±1 kHz to provide addressing information according to an ATIP (absolute time in pre-groove) scheme.

The resulting optical recording disc was initialized with an elliptic laser beam having a wavelength of 810 nm, a major axis length of about 108 μm, and a minor axis length of about 1.5 μm (with the longer axis agreeing with the radial direction of the disc) at a beam scanning speed of 3 to 6 m/sec and a power of 400 to 600 mW (the value of initializing power density divided by the linear velocity of said elliptic laser beam was less than 0.85 mW·s/μm²·m). The ΔR of the thus initialized medium is 12 to 20%, which indicates that the above-described initialization conditions failed to create the specific hexagonal structure according to the invention. That is, the initialization conditions adopted here only provide an optical recording medium of high noise unfit for practical use.

The optical recording medium according to the present invention enables recording with excellent jitter characteristics in a broad range of recording linear velocity including a high velocity of 10 m/sec or even higher. The recording medium of the invention also exhibits excellent jitter characteristics after repeated overwriting. Hence the present invention provides an optical recording medium capable of overwriting at a high linear velocity and excellent in archival stability.

While the invention has been described in detail and with reference to specific examples thereof, it will be apparent to one skilled in the art that various changes and modifications can be made therein without departing from the spirit and scope thereof.

This application is based on Japanese Patent Application No. 2001-64877 filed on Mar. 8, 2001 and Japanese Patent Application No. 2001-326408 filed on Oct. 24, 2001, the entire contents thereof being hereby incorporated for reference.

What is claimed is:

1. An optical recording medium having a recording layer which comprises an Sb—Te alloy containing excess amount of Sb over the vicinity of Sb₇₀Te₃₀ eutectic composition and shows reversible phase changes on light beam irradiation between a crystalline state and an amorphous state differing from each other in optical properties, wherein:
the polycrystalline state after initial crystallization mainly comprises a substantially single phase composed of hexagonal structure which is preferentially oriented,
said polycrystalline state has a columnar structure having grown in the same direction, and
the reflectance R1 of a non-recorded region of said optical recording medium after initial crystallization and the reflectance R2 of an erased region of said optical recording medium after 10th overwriting satisfy relationship (1):
ΔR (%)=2|R1−R2|/(R1+R2)×100≦10 (1)

2. The optical recording medium according to claim 1, wherein the direction of preferential orientation after initial crystallization and the direction of preferential orientation in a crystalline state after overwriting and erasing with a focused light beam are the same.

3. The optical recording medium according to claim 1, wherein said crystalline state after initial crystallization mainly comprises a substantially single phase composed of Sb hexagonal structure belonging to the space group R3m and having part of Sb atoms displaced with Te atoms, and said hexagonal structure being preferentially oriented.

4. The optical recording medium according to claim 1, wherein said crystalline state after initial crystallization is composed solely of Sb hexagonal structure belonging to the space group R3m and having part of Sb atoms displaced with Te atoms.

5. The optical recording medium according to claim 1, wherein the growth direction of said columnar structure is almost along the scanning direction of said light beam.

6. The optical recording medium according to claim 1, wherein said columnar structure does not have a clear grain boundary and has continuous and small fluctuations of crystalline structure in its growth direction.

7. The optical recording medium according to claim 6, wherein said fluctuations of orientation occur at a period of 0.5 μm or less, said period being observed as contrast variations in a transmission electron microscopic image at a non-recorded region of said recording layer after initial crystallization.

8. The optical recording medium according to claim 1, wherein said crystalline state after initial crystallization shows an X-ray diffraction pattern prepared by thin film X-ray diffractometry using CuKα radiation as an X-ray source, in which the predominant peak is the peak for the (012) plane of hexagonal crystals appearing at a diffraction angle 2θ of about 28°.

9. The optical recording medium according to claim 8, wherein said X-ray diffraction pattern has a clear, non-divided peak at a diffraction angle 2θ of about 40°.

10. The optical recording medium according to claim 1, wherein the hexagonal crystal unit cells in said crystalline state after initial crystallization have a shorter c-axis length than hexagonal crystals of pure Sb.

11. The optical recording medium according to claim 10, wherein the hexagonal crystal unit cells in said crystalline state after initial crystallization have an a-axis length of from 4.30 to 4.33 Å and a c-axis length of from 10.9 to 11.25 Å.

12. The optical recording medium according to claim 1, wherein said crystalline state after initial crystallization is such that an X-ray diffraction pattern thereof obtained by a thin film X-ray diffraction method using CuKa radiation as an X-ray source has a predominant peak at a position within a diffraction angle 2θ range of from 28.70° to 28.85°.

13. The optical recording medium according to claim 12, wherein said crystalline state after initial crystallization is such that said predominant peak has a half-value width of 0.6 to 0.8° as obtained with only CuKα1 radiation.

14. The optical recording medium according to claim 1, wherein said recording layer mainly comprises a composition represented by formula: SbₓTe₁₋ₓ (0.75≦x≦0.9).

15. The optical recording medium according to claim 14, wherein said recording layer mainly comprises a composition represented by formula: M_{y}(SbₓTe₁₋ₓ)_{1-y}, wherein M represents at least one element selected from the group consisting of Al, In, Ga, Ge, Si, Sn, Pb, Pd, Pt, Zn, Zr, Hf, V, Nb, Ta, Cr, Co, Mo, Mn, Bi, O, N, S, and Se; 0.75≦x≦0.9; and 0≦y≦0.2.

16. The optical recording medium according to claim 15, wherein M is Ge, and 0.001≦y≦0.08.

17. The optical recording medium according to claim 15, wherein said recording layer mainly comprises a composition represented by formula: A_{z}Ge_{y} (SbₓTe₁₋ₓ)_{1-y} wherein A represents at least one of In and Ga; 0.75≦x≦0.9; 0.001<y<0.08; and 0.03≦(y+z)≦0.1.

18. A method of writing and erasing information comprising using the optical recording medium according to claim 1 and conducting writing and/or erasing using a crystalline state of the recording layer as a non-recorded or erased state and an amorphous state as a recorded state.

19. A process of producing the optical recording medium according to claim 1, which comprises forming at least said recording layer on a substrate and crystallizing said recording layer for initialization by scanning with an elliptic light beam having a minor axis length of 0.5 to 5 μm in a direction agreeing with said minor axis of said elliptic light beam at a scanning speed of 20% to 60% of a maximum possible linear velocity for overwriting said recording layer.

20. The process of producing an optical recording medium according to claim 19, wherein the scanning speed is 20% or more and less than 50% of said maximum possible linear velocity for overwriting.

21. A process of producing an optical recording medium having a recording layer mainly comprising a composition represented by formula: SbₓTe₁₋ₓ (0.75≦x≦0.9) and showing reversible phase changes between a crystalline state and an amorphous state differing from each other in optical properties, which comprises forming at least said recording layer on a substrate and crystallizing said recording layer for initialization by scanning with an elliptic light beam having a minor axis length of 0.5 to 5 μm in a direction agreeing with said minor axis of said elliptic light beam at a scanning speed of 20% or more and less than 50% of a maximum possible linear velocity for overwriting said recording layer.

22. A process of producing an optical recording medium according to claim 19, which essentially comprises (1) a first protective layer having a thickness of 10 to 100 nm, (2) a recording layer having a thickness of 1 to 20 nm, mainly comprising a composition represented by formula: SbₓTe₁₋ₓ (0.75≦x≦0.9) and showing reversible phase changes on light beam irradiation between a crystalline state and an amorphous state differing from each other in optical properties, (3) a second protective layer having a thickness of 1 to 50 nm, and (4) a reflective layer having a sheet resistivity of 0.2 to 0.6 Ω/□ in this order, has a reflectance of 15 to 25% when retrieving light is incident on said recording layer from the side of said first protective layer, and has maximum possible overwriting linear velocity of at least 15 m/sec or more, the process comprising forming at least said recording layer on a substrate and crystallizing said recording layer for initialization by scanning with an elliptic light beam having a wavelength of 750 to 850 nm and a minor axis length of 1 to 2 μm in the direction agreeing with said minor axis direction of said elliptic light beam at a linear velocity of 5 to 15 m/sec, wherein the power density of said elliptic light beam divided by the linear velocity of said elliptic light beam is in a range of from 0.85 to 1.2 mW·s/(μm²·m).
